(19) United States
(12) Patent Application Publication
(10) Pub. No.: US 2024/0341360 A1
(43) Pub. Date: Oct. 17, 2024

(54) AEROSOL GENERATION SYSTEM, AND AEROSOL-FORMING PRODUCT

(71) Applicant: Japan Tobacco Inc., Tokyo (JP)

(72) Inventors: Takahiro SAKAMOTO, Tokyo (JP); Reijiro KAWASAKI, Tokyo (JP)

(73) Assignee: Japan Tobacco Inc., Tokyo (JP)

(21) Appl. No.: 18/752,838

(22) Filed: Jun. 25, 2024

Related U.S. Application Data
(63) Continuation of application No. PCT/JP2021/048920, filed on Dec. 28, 2021.

(51) Int. Cl. A24F 40/46; A24D 1/20; A24F 40/20; A24F 40/51; A24F 40/53; A24F 40/57; H05B 6/80

(52) U.S. Cl. CPC A24F 40/46; A24D 1/20; A24F 40/20; A24F 40/51; A24F 40/53; A24F 40/57; H05B 6/802

(57) ABSTRACT

An aerosol generation system including: an aerosol-forming product including an aerosol source; an accommodating portion accommodating the aerosol-forming product; a microwave oscillation unit; a power supply unit; an antenna that supplies the microwave to the accommodating portion; and a control unit, in which the accommodating portion includes a first microwave shield, the aerosol-forming product includes a second microwave shield, the first microwave shield and the second microwave shield form an applicator that confines the microwave, the applicator transitions between a blocking state in which propagation of the microwave from the applicator to the outside is restricted and a non-blocking state in which propagation of the microwave from the applicator to the outside is enabled, according to a position of the second microwave shield, and the control unit prohibits supply of the microwave from the microwave oscillation unit according to the position of the second microwave shield.

### CROSS-REFERENCE TO RELATED APPLICATION

This application is a continuation of International Patent Application No. PCT/JP2021/048920, filed on Dec. 28, 2021, the content of which is incorporated herein by reference.

### TECHNICAL FIELD

The present invention relates to an aerosol generation system and an aerosol-forming product.

### BACKGROUND ART

An aerosol generation device such as a heated tobacco product is provided with a heating unit that heats an aerosol-forming product (a capsule, a stick, or the like) in which an aerosol source is incorporated. WO2021/013477 discloses an aerosol generation device in which a high frequency oscillator that produces microwaves (electromagnetic waves having a frequency between 300 MHz and 300 GHz) is used as a heating unit, and discloses a configuration in which an aerosol source is heated by the microwaves. The heating method using microwaves has the advantages that the aerosol source can be heated uniformly, and that accumulation of residues from the aerosol source can be prevented from being accumulated on the heating unit because of non-contact heating.

In the heating method using microwaves, when an aerosol-forming product disposed in a chamber is heated, it is important that the microwaves are reliably consumed in the chamber. If the microwaves leak to the outside of the aerosol generation device, unintended effects may be exerted on the outside (a user, surrounding electronic equipment, or the like) of the aerosol generation device.

In order to prevent leakage of the microwaves, it is conceivable to incorporate a microwave shield into the aerosol-forming product. In this case, when the aerosol-forming product is inserted into the chamber of the aerosol generation device, if the supply of the microwaves is started without the microwave shield being in an appropriate position, the microwaves may leak to the outside of the aerosol generation device. In addition, in a case where the aerosol-forming product is removed during the supply of the microwaves, if the control to stop the supply of the microwaves is not appropriate, the microwaves may leak to the outside.

An object of the present invention is to provide an aerosol generation system and an aerosol-forming product that can prevent leakage of microwaves to the outside of the aerosol generation system.

### SUMMARY OF INVENTION

According to an aspect of the present invention, there is provided an aerosol generation system including:
an aerosol-forming product including an aerosol source;
an accommodating portion capable of accommodating at least a part of the aerosol-forming product through an opening;
a microwave oscillation unit that produces a microwave;
a power supply unit that supplies power to the microwave oscillation unit;
an antenna that supplies the microwave to the accommodating portion; and
a control unit that controls the microwave oscillation unit, in which
the accommodating portion includes a first microwave shield that blocks the microwave,
the aerosol-forming product includes a second microwave shield that blocks the microwave and allow air to pass through,
the first microwave shield and the second microwave shield cooperate with each other to form an applicator that confines the microwave,
the applicator transitions between a blocking state in which propagation of the microwave from the applicator to the outside is restricted and a non-blocking state in which propagation of the microwave from the applicator to the outside is enabled, according to a position of the second microwave shield, and
the control unit prohibits supply of the microwave from the microwave oscillation unit according to the position of the second microwave shield.

According to another aspect of the present invention, there is provided an aerosol-forming product heated by a microwave, the aerosol-forming product including:
an aerosol source;
a microwave shield that is disposed side by side with the aerosol source in a predetermined direction and blocks the microwave and allow air to pass through; and
a conductive portion electrically connected to the microwave shield, in which
the conductive portion is provided on an outer peripheral surface of the aerosol-forming product and extends from a position of the microwave shield toward the aerosol source in the predetermined direction.

### BRIEF DESCRIPTION OF DRAWINGS

FIG. 1 is a schematic diagram of an aerosol generation system 1 according to a first embodiment of the present invention.

FIG. 2 is a schematic diagram showing a first position P1 to a third position P3 of a microwave shield SD2 of a tobacco stick 100.

FIG. 3 is a time chart showing the steps from attachment, heating, and removal of the tobacco stick 100 to a flavor inhaler 10 of the first embodiment.

FIG. 4 is a flowchart showing a control flow related to the supply of microwaves when the tobacco stick 100 is attached to the flavor inhaler 10 of the first embodiment.

FIG. 5 is a flowchart showing a control flow related to the supply of microwaves when the tobacco stick 100 is removed from the flavor inhaler 10 of the first embodiment when the tobacco stick 100 is being heated.

FIG. 6 is a schematic diagram of an aerosol generation system 1 according to a second embodiment of the present invention.

FIG. 7 is a time chart showing the steps from attachment, heating, and removal of the tobacco stick 100 to the flavor inhaler 10 of the second embodiment.

FIG. 8 is a flowchart showing a control flow related to the supply of microwaves when the tobacco stick 100 is attached to the flavor inhaler 10 of the second embodiment.

FIG. 9 is a flowchart showing a control flow related to the supply of microwaves when the tobacco stick 100 is removed from the flavor inhaler 10 of the second embodiment when the tobacco stick 100 is being heated.

FIG. 10 is a schematic diagram of a tobacco stick 100 according to a modification of the present invention.

FIG. 11 is a schematic diagram of a flavor inhaler 10 according to a modification of the present invention.

FIG. 12 is a perspective view showing a configuration of the tobacco stick 100.

FIG. 13 is a cross-sectional view showing the configuration of the tobacco stick 100.

### DESCRIPTION OF EMBODIMENTS

Hereinafter, aerosol generation systems according to respective embodiments of the present invention will be described with reference to the drawings.

### First Embodiment

### (Overview of Aerosol Generation System 1)

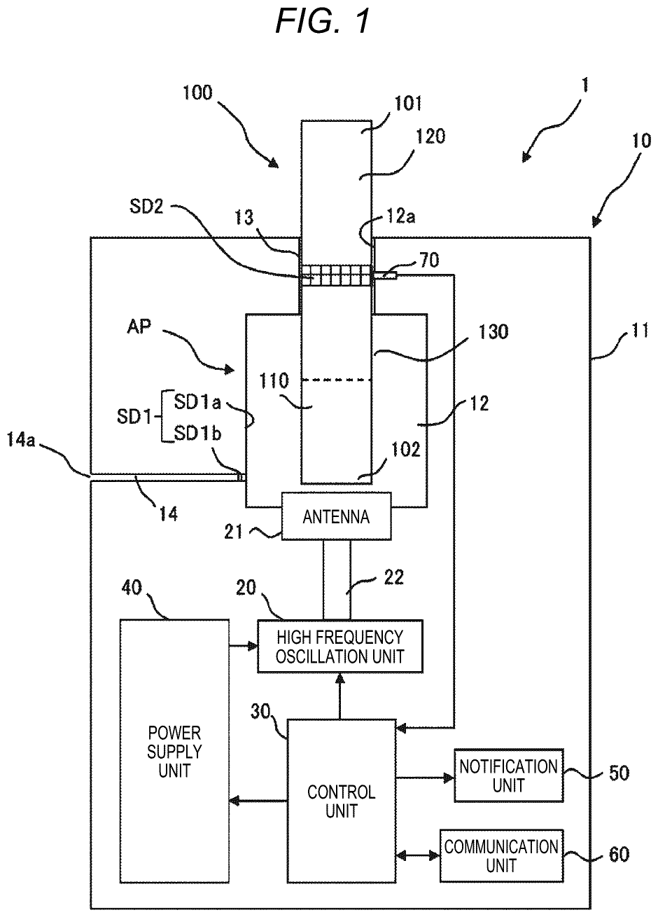

An aerosol generation system 1 according to a first embodiment of the present invention will be described with reference to FIG. 1. The aerosol generation system 1 does not need to include all of the following configurations, and may not include some of the components.

The aerosol generation system 1 includes a tobacco stick 100 in which a flavor source and an aerosol source are incorporated, and a flavor inhaler 10 for generating aerosol by heating the aerosol source by microwaves and suctioning the generated aerosol. The aerosol generation system 1 is preferably of a size that fits in hands.

The tobacco stick 100 according to the present embodiment has a substantially cylindrical rod shape. The tobacco stick 100 includes a tobacco rod portion 110, a mouthpiece portion (mouthpiece) 120, and tipping paper 130 that integrally connects the tobacco rod portion 110 and the mouthpiece portion 120. The mouthpiece portion 120 is coaxially connected to the tobacco rod portion 110 by being wrapped together with the tobacco rod portion 110 using the tipping paper 130. Although not particularly illustrated, the tobacco stick 100 may have a plug portion formed of a filter segment or the like at an end upstream of the tobacco rod portion 110 to prevent a tobacco filler from falling off. Here, the tobacco stick 100 corresponds to an “aerosol-forming product” in the present invention. The tobacco rod portion 110 corresponds to the “aerosol source” in the present invention.

Reference numeral 101 denotes a mouthpiece of the tobacco stick 100 (the mouthpiece portion 120). Reference numeral 102 denotes a tip opposite to the mouthpiece 101 of the tobacco stick 100. The tobacco rod portion 110 is disposed closer to the tip 102 of the tobacco stick 100.

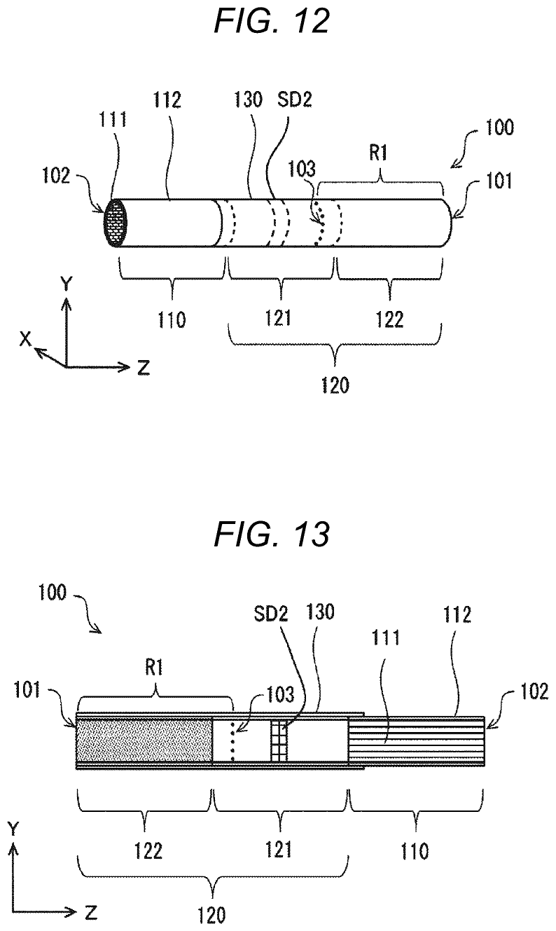

The mouthpiece portion 120 is provided with a microwave shield SD2 that blocks the microwaves and allows air to pass through. The tobacco stick 100 is attachable to and detachable from the flavor inhaler 10 such that the microwave shield SD2 and the tobacco rod portion 110 are disposed inside the flavor inhaler 10. Details of the tobacco stick 100 will be described later with reference to FIGS. 12 and 13.

The flavor inhaler 10 includes a case 11 on which various components to be described later are mounted. The case 11 is provided with an accommodating portion 12 capable of accommodating at least a part of the tobacco stick 100 through an opening 12a, a guide portion 13 disposed between the opening 12a and the accommodating portion 12 for guiding insertion of the tobacco stick 100, and an air flow path 14 that communicates with the accommodating portion 12 and can introduce air into the accommodating portion 12. The guide portion 13 is a hole having substantially the same size as an outer diameter of the tobacco stick 100, and communicates with the accommodating portion 12. The air flow path 14 has an air intake port 14a that opens to the outside. The air flow path 14 may be provided at any position, and may be provided on a bottom surface of the accommodating portion 12 or along the guide portion 13.

The flavor inhaler 10 further includes a high frequency oscillation unit 20, an antenna 21, a control unit 30, a power supply unit 40, a notification unit 50, a communication unit 60, and a shielding detection sensor 70. These components will be described in detail below.

The high frequency oscillation unit 20 is, for example, a solid state oscillator, and generates a high frequency electromagnetic field of a predetermined frequency. The solid state oscillator is, for example, an LDMOS transistor, a GaAs FET, a SiC MESFET, or a GaN HFET. In the present description, the high frequency electromagnetic field means a high frequency electromagnetic field between 3 Hz and 3 THz. The microwave means a high frequency electromagnetic field between 300 MHz and 300 GHz. Although not particularly limited, the high frequency oscillation unit 20 may generate microwaves having a frequency of 2.40 GHz to 2.50 GHz. In the present embodiment, the high frequency oscillation unit 20 generates microwaves having a frequency of 2.45 GHz. Here, the high frequency oscillation unit 20 corresponds to a “microwave oscillation unit” in the present invention.

The high frequency oscillation unit 20 may include an amplifier for amplifying the high frequency electromagnetic field. The high frequency oscillation unit 20 may have a function of an amplifier, or an electronic component different from the high frequency oscillation unit 20 may be used to provide an amplifier.

A magnetron oscillator is also available as a device for generating a high frequency electromagnetic field. When a solid state oscillator is used as the high frequency oscillation unit 20, a main body can be made smaller than when a magnetron oscillator is used. The semiconductor oscillator can operate at a lower operating voltage than the magnetron oscillator, and has high frequency stability and output stability. However, the high frequency oscillation unit 20 of the present embodiment may be a magnetron oscillator as long as the high frequency oscillation unit 20 can generate a high frequency electromagnetic field of a predetermined frequency.

The microwaves generated by the high frequency oscillation unit 20 propagates through a waveguide 22 and are guided to the antenna 21. The antenna 21 radiates the microwaves for heating the aerosol source into the accommodating portion 12. A coaxial cable may be used instead of the waveguide 22. When the high frequency oscillation unit 20 and the antenna 21 are directly connected, the waveguide 22 or the coaxial cable may be omitted.

The antenna 21 has, for example, a rod shape and radiates the microwaves outward in a radial direction. An antenna length can be appropriately set according to a frequency of high-frequency electromagnetic waves to be radiated. For example, when the antenna 21 is a rod-shaped antenna (a dipole antenna) and the frequency of the generated microwaves is 2.45 GHz (a wavelength is about 120 mm), the antenna length can be set to about 30 mm (that is, ¼ of the wavelength). An antenna diameter is, for example, 1 mm. The shape of the antenna 21 is not limited to a rod shape, and for example, a planar antenna (such as a patch antenna) may be used.

The antenna 21 is disposed such that an oscillation portion of the microwaves faces the accommodating portion 12. Various aspects can be adopted for the arrangement of the antenna 21. At least a part of the antenna 21 may be disposed to be located in the accommodating portion 12. At least a part of the antenna 21 may be disposed to be inserted into or punctured into the tobacco stick 100 inside the accommodating portion 12. Further, the antenna 21 may be disposed to be in contact with the tobacco stick 100, or may be disposed to be separated from the tobacco stick 100. Further, the antenna 21 may not be located in the accommodating portion 12, and a waveguide may be provided between the antenna 21 and the accommodating portion 12.

The waveguide 22 is a tube that connects the high frequency oscillation unit 20 and the antenna 21 and guides the microwaves generated by the high frequency oscillation unit 20 to the antenna 21. The waveguide 22 may be provided with an isolator that protects the high frequency oscillation unit 20 by absorbing reflected waves that are not absorbed by the tobacco stick 100 and return toward the high frequency oscillation unit 20. The waveguide 22 may be provided with a power monitor that detects the power of incident waves from the high frequency oscillation unit 20 and the power of the reflected waves from the tobacco stick 100, or an impedance matching unit that matches the impedance of the high frequency oscillation unit 20 and the impedance of the tobacco stick 100 to reduce the power of the reflected waves.

The control unit 30 functions as an arithmetic processing device and a control device, and controls overall operations in the flavor inhaler 10 according to various programs. The control unit 30 is implemented by, for example, an electronic circuit such as a central processing unit (CPU) or a microprocessor.

The power supply unit 40 supplies power to the high frequency oscillation unit 20 under the control of the control unit 30. The power supply unit 40 includes, for example, a rechargeable battery such as a lithium ion secondary battery.

The notification unit 50 notifies a user of information under the control of the control unit 30. The information notified to the user is, for example, detection of insertion of the tobacco stick 100, start of heating using microwaves, transition to a state in which aerosol can be inhaled, error information, remaining power of the power supply unit 40, and the like. The notification unit 50 may be implemented by a light-emitting element such as an LED, a vibration element such as a vibration motor, or a sound output element. The notification unit 50 may be a combination of two or more elements among the light-emitting element, the vibration element, and the sound output element.

The communication unit 60 is an interface that acquires information related to a use state of the flavor inhaler 10, transmits the information to an external data server, a mobile terminal device of a user, or the like (hereinafter, referred to as a data server or the like), and receives data from the data server or the like. For example, the communication unit 60 transmits, to the data server or the like, information related to the use state of the flavor inhaler 10, such as error information and information on the date and time of use. Thus, a manufacturer of the flavor inhaler 10 can know the use state of the flavor inhaler 10, and can create information related to updates of firmware built in the control unit 30. The communication unit 60 can receive the information related to the updates of the firmware.

The communication unit 60 can communicate with the data server or the like using, for example, Bluetooth (registered trademark), which is near range wireless communication, or a low power wide area (LPWA), which is far range wireless communication. The communication between the communication unit 60 and the data server or the like is not limited to the above wireless communication, and may be wireless communication in another form or wired communication.

The shielding detection sensor 70 is a sensor that detects a position of the microwave shield SD2 of the tobacco stick 100. The shielding detection sensor 70 is, for example, an inductive proximity sensor or a capacitive proximity sensor, but is not limited thereto, and may be a contact sensor such as a pressure sensor, a photoelectric sensor, or the like. The shielding detection sensor 70 is provided on an inner peripheral surface of the guide portion 13 to be described later, and is disposed at a position corresponding to the position of the microwave shield SD2 in an insertion direction of the tobacco stick 100 when insertion of the tobacco stick 100 is completed. Here, the shielding detection sensor 70 corresponds to a “detection unit” and a “first detection unit” in the present invention.

### (Microwave Shielding Structure)

Next, a microwave shielding structure formed by the accommodating portion 12, the guide portion 13, and the tobacco stick 100 will be described.

A microwave shield SD1 is formed on inner peripheral surfaces of the accommodating portion 12 and the guide portion 13 and in the air flow path 14 such that the microwaves from the high frequency oscillation unit 20 do not leak to the outside. The microwave shield SD1 includes a microwave shield SD1a formed on the inner peripheral surfaces of the accommodating portion 12 and the guide portion 13, and a microwave shield SD1b formed near the accommodating portion 12 in the air flow path 14.

The microwave shield SD1a is made of a material that does not transmit microwaves, and is, for example, a metal layer formed of at least one material selected from the group consisting of aluminum, stainless steel, silver, gold, copper, nickel, chromium, and alloys containing aluminum, stainless steel, silver, gold, copper, nickel, or chromium. The metal layer is formed by, for example, plating or attaching a film. In addition, instead of the metal layer, the accommodating portion 12 and the guide portion 13 may be metal moldings, and in that case, the accommodating portion 12 and the guide portion 13 constitute the microwave shield SD1a.

The microwave shield SD1b is provided with a plurality of holes, and the microwave shield SD1b blocks microwaves and allows air to pass through. Similarly to the microwave shield SD1a, the microwave shield SD1b is made of a material that does not transmit microwaves. The microwave shield SD1b is, for example, a metal mesh or punched metal. The microwave shield SD1b may be formed by coating a surface of a material such as resin with the above metal material. With such a configuration, a lightweight and inexpensive microwave shield SD1b can be formed. The microwave shield SD1b may be provided near the air intake port 14a. Here, the microwave shield SD1 corresponds to a “first microwave shield” in the present invention.

The microwave shield SD2 of the tobacco stick 100 is provided with a plurality of holes so as to block microwaves and allow air to pass through. The microwave shield SD2 is, for example, a metal mesh or punched metal. Similarly to the microwave shield SD1, the microwave shield SD2 is made of a material that does not transmit microwaves, and is made of, for example, at least one material selected from the group consisting of aluminum, stainless steel, silver, gold, copper, nickel, chromium, and alloys containing aluminum, stainless steel, silver, gold, copper, nickel, or chromium. The microwave shield SD2 may be formed by coating a surface of a material such as resin with the above metal material. With such a configuration, a lightweight and inexpensive microwave shield SD2 can be formed. Here, the microwave shield SD2 corresponds to a “second microwave shield” in the present invention.

When the tobacco stick 100 is reliably attached to the flavor inhaler 10, the microwave shield SD2 is disposed at a position where the guide portion 13 is formed in the insertion direction of the tobacco stick 100. Thus, the microwaves propagated from the accommodating portion 12 toward the microwave shield SD2 are further blocked by the microwave shield SD2. The microwave shield SD2 is disposed at a predetermined distance from the opening 12a when the tobacco stick 100 is attached. This is to prevent the microwave shield SD2 being immediately located outside the guide portion 13 and causing the microwaves to leak in a case where the tobacco stick 100 is unintentionally detached from the flavor inhaler 10 by the user when the tobacco stick 100 is heated by the microwaves.

As described above, holes are formed in the microwave shield SD1b and the microwave shield SD2 so that air can pass through. In general, when a diameter of a hole is smaller than a half wavelength of microwaves, the microwaves are blocked without passing through the hole, and therefore, the diameter of the hole needs to be smaller than the half wavelength of the microwaves. In the present embodiment, since the wavelength of the microwaves having a frequency of 2.45 GHz is about 120 mm, a diameter of the hole may be smaller than 60 mm.

In general, since the outer diameter of the tobacco stick 100 is designed to be smaller than 60 mm, a diameter of each of the holes formed in the microwave shield SD2 is also designed to be smaller than 60 mm. A diameter of each of the holes formed in the microwave shield SD1b is also designed to be smaller than 60 mm. However, even if the diameter of the hole is smaller than 60 mm, a part of the microwaves may leak if the hole has a certain size. Further, even if an aperture ratio (a ratio of the holes to an area of the microwave shield) is large, a part of the microwaves may leak. Therefore, in order to prevent leakage of the microwaves, it is preferable to reduce the diameter of the hole and the aperture ratio, but as the diameter of the hole and the aperture ratio are reduced, the difficulty of air passage (ventilation resistance) increases. Therefore, the diameter of the hole and the aperture ratio are preferably designed in consideration of the blocking of the microwaves and the ventilation resistance.

The microwave shield SD1 and the microwave shield SD2 configured as described above cooperate with each other to form an applicator AP for confining the microwaves from the high frequency oscillation unit 20. When the microwave shield SD2 is located inside the guide portion 13, the applicator AP is in a blocking state in which propagation of the microwaves from the applicator AP to the outside is restricted, and when the microwave shield SD2 is located outside the guide portion 13 (that is, outside the flavor inhaler 10), the applicator AP is in a non-blocking state in which propagation of the microwaves from the applicator AP to the outside is enabled. That is, the applicator AP transitions between the blocking state and the non-blocking state according to the position of the microwave shield SD2.

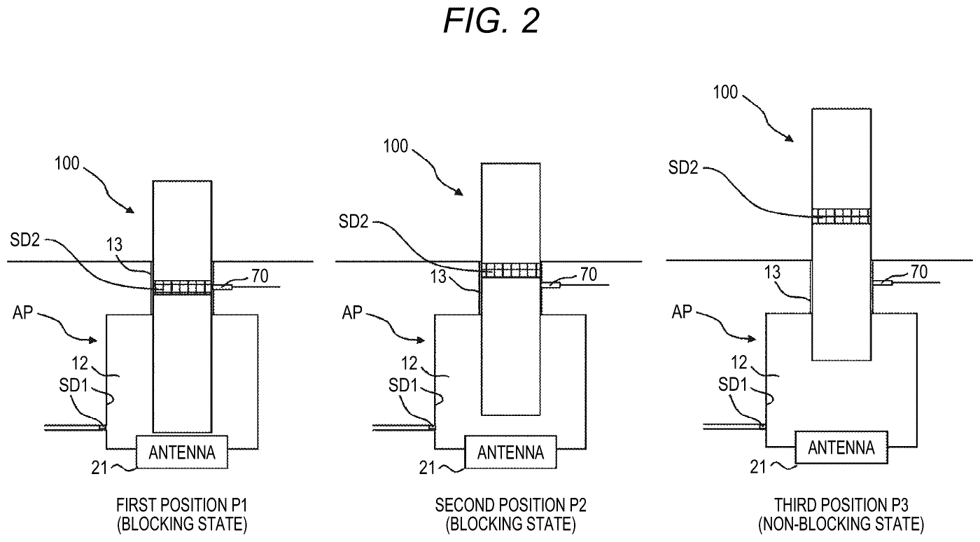

As shown in FIG. 2, when the microwave shield SD2 is located inside the guide portion 13 and the insertion of the tobacco stick 100 is completed, the position of the microwave shield SD2 is referred to as a first position P1. When the microwave shield SD2 is in the first position P1, the shielding detection sensor 70 detects the position of the microwave shield SD2 and is in an ON state. Next, when detachment of the tobacco stick 100 is started, the microwave shield SD2 is in a state in which the microwave shield SD2 is located inside the guide portion 13 and the insertion of the tobacco stick 100 is not completed. The position of the microwave shield SD2 at this time is referred to as a second position P2. The second position P2 is a position further away from the accommodating portion 12 than the first position P1. When the tobacco stick 100 is further detached, the microwave shield SD2 is located outside the guide portion 13. The position of the microwave shield SD2 at this time is referred to as a third position P3. The third position P3 is a position further away from the accommodating portion 12 than the second position P2. Thus, the microwave shield SD2 is movable between the first position P1, the second position P2, and the third position P3.

As described above, the applicator AP transitions between the blocking state and the non-blocking state according to the position of the microwave shield SD2, that is, the first position P1 to the third position P3 of the microwave shield SD2. Specifically, when the microwave shield SD2 is in the first position P1 or the second position P2, the microwave shield SD2 is located inside the guide portion 13, and thus the applicator AP is in the blocking state. On the other hand, when the microwave shield SD2 is located at the third position P3, the microwave shield SD2 is located outside the guide portion 13, and thus the applicator AP is in the non-blocking state.

### (Control of Supply of Microwaves)

Next, the control related to supply of microwaves when the tobacco stick 100 is inserted into the flavor inhaler 10 and when the tobacco stick 100 is detached from the flavor inhaler 10 will be described. The control is executed by the control unit 30. In relation to the detachment of the tobacco stick 100, a case where the tobacco stick 100 is detached by the user when the tobacco stick 100 is being heated will be described below. Therefore, the description of a case where the tobacco stick 100 is detached after the heating of the tobacco stick 100 is normally completed or forcibly completed due to an error will be omitted.

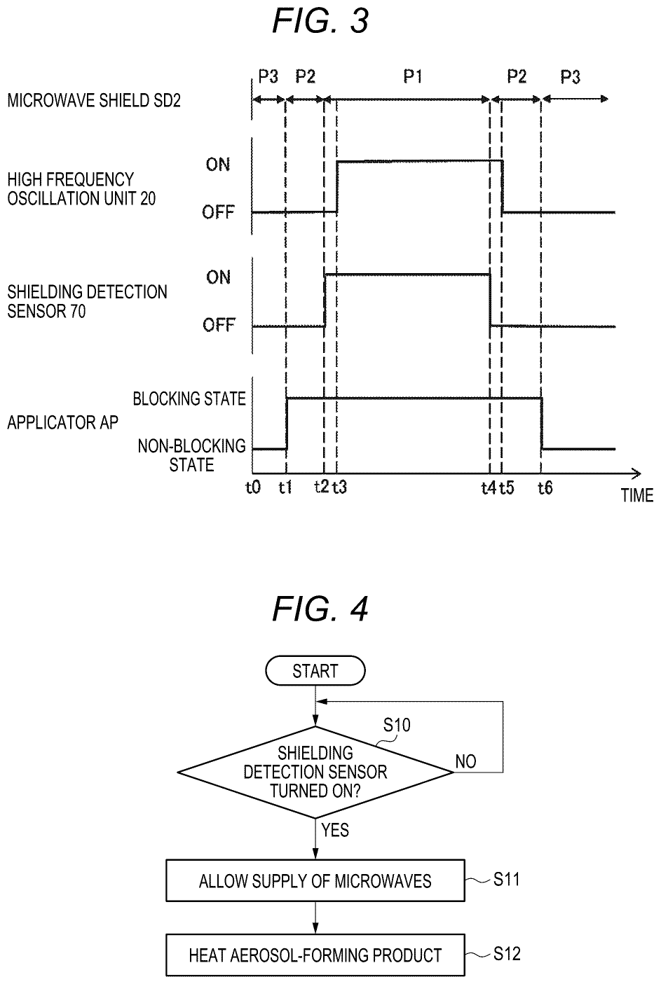

First, with reference to FIGS. 3 and 4, a control flow related to the supply of microwaves when the tobacco stick 100 is inserted into the flavor inhaler 10 will be described.

As shown in FIG. 3, at time to, which is an initial state, the position of the microwave shield SD2 is in the third position P3. At this time, the high frequency oscillation unit 20 is in an OFF state, the shielding detection sensor 70 is in an OFF state, and the applicator AP is in the non-blocking state. When the tobacco stick 100 is inserted, the microwave shield SD2 is located at the second position P2 at time t1. At this time, although the applicator AP is in a blocking state, the high frequency oscillation unit 20 is maintained in the OFF state and the shielding detection sensor 70 is maintained in the OFF state. When the tobacco stick 100 is further inserted, the microwave shield SD2 reaches a first position at time t2. At this time, the shielding detection sensor 70 detects that the microwave shield SD2 is disposed at the first position, and the shielding detection sensor 70 is in the ON state. The shielding detection sensor 70 transmits a signal indicating the ON state to the control unit 30. The high frequency oscillation unit 20 is maintained in the OFF state.

At time t3, the control unit 30 switches the high frequency oscillation unit 20 to an ON state in response to receiving the signal from the shielding detection sensor 70, and allows the supply of microwaves from the high frequency oscillation unit 20. After time t3, the tobacco stick 100 is heated.

FIG. 4 shows a control flow by the control unit 30. When the tobacco stick 100 is inserted into the flavor inhaler 10, in step S10, the control unit 30 determines whether the shielding detection sensor 70 detects that the microwave shield SD2 is disposed at the first position, that is, whether the shielding detection sensor 70 is in the ON state. When the shielding detection sensor 70 is not in the ON state (NO), the process returns to step S10 again, and the control unit 30 monitors the shielding detection sensor 70 until the shielding detection sensor 70 is in the ON state. When the shielding detection sensor 70 is in the ON state (YES), the process proceeds to step S11. In step S11, the control unit 30 allows the supply of microwaves from the high frequency oscillation unit 20, and in step S12, the tobacco stick 100 is heated.

In step S12, heating may be started in response to an operation of the user such as pressing a button provided on the flavor inhaler 10, or heating may be automatically started after the end of step S11. In the state of step S10, when an instruction to start heating is given by the operation of the user such as pressing a button, the supply of microwaves is prohibited, and the notification unit 50 notifies the user that heating will not start.

As described above, when the microwave shield SD2 is disposed at the first position, the control unit 30 allows the supply of the microwaves from the high frequency oscillation unit 20. Therefore, the possibility of microwave leakage to the outside can be reduced.

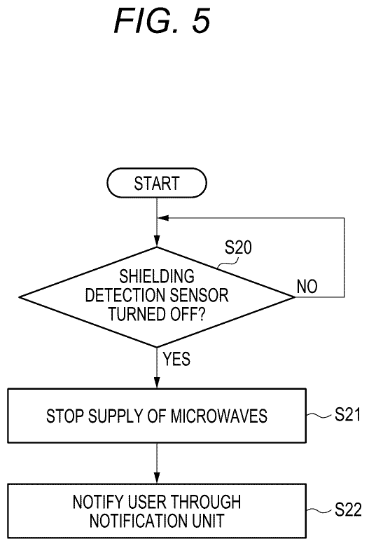

Next, with reference to FIGS. 3 and 5, a control flow related to the supply of microwaves when the tobacco stick 100 is detached from the flavor inhaler 10 will be described.

After the time t3 at which heating of the tobacco stick 100 is executed, the user may pull out the tobacco stick 100. The tobacco stick 100 may be unintentionally detached by the user. In this case, if the supply of microwaves is not prohibited before the applicator AP enters the non-blocking state, the microwaves may leak to the outside of the flavor inhaler 10. Therefore, in the present embodiment, the control unit 30 is configured to prohibit the supply of microwaves in response to the transition of the shielding detection sensor 70 from the ON state to the OFF state.

Specifically, as shown in FIG. 3, at time t4, detachment of the tobacco stick 100 is started, and the microwave shield SD2 is located at the second position P2. At this time, although the shielding detection sensor 70 is in the OFF state, the applicator AP is maintained in the blocking state. When the shielding detection sensor 70 is in the OFF state, the shielding detection sensor 70 no longer transmits the signal indicating the ON state as described above, and the reception of the signal by the control unit 30 is stopped. Thus, at time t5, the control unit 30 switches the high frequency oscillation unit 20 to the OFF state to stop the supply of the microwaves from the high frequency oscillation unit 20. When the tobacco stick 100 is further detached, the microwave shield SD2 is located at the third position outside the guide portion 13 at time t6. At this time, the applicator AP transitions to the non-blocking state.

FIG. 5 shows a control flow by the control unit 30. During heating by microwaves, in step S20, the control unit 30 determines whether the shielding detection sensor 70 is switched to the OFF state. When the shielding detection sensor 70 is not switched to the OFF state (NO), the process returns to step S20 again, and the control unit 30 monitors the shielding detection sensor 70 until the shielding detection sensor 70 is switched to the OFF state. When the shielding detection sensor 70 is switched to the OFF state (YES), the process proceeds to step S21. In step S21, the control unit 30 stops the supply of the microwaves from the high frequency oscillation unit 20, and the process proceeds to step S22. In step S22, the notification unit 50 notifies the user that the supply of the microwaves is stopped.

As described above, when the shielding detection sensor 70 is switched from the ON state to the OFF state and the microwave shield SD2 is disposed at the second position P2 which is the blocking state, the control unit 30 is configured to stop the supply of the microwaves from the high frequency oscillation unit 20. Therefore, the supply of the microwaves can be prohibited before the applicator AP enters the non-blocking state, and the possibility of microwave leakage to the outside can be reduced.

### Second Embodiment

### (Overview of Aerosol Generation System 1)

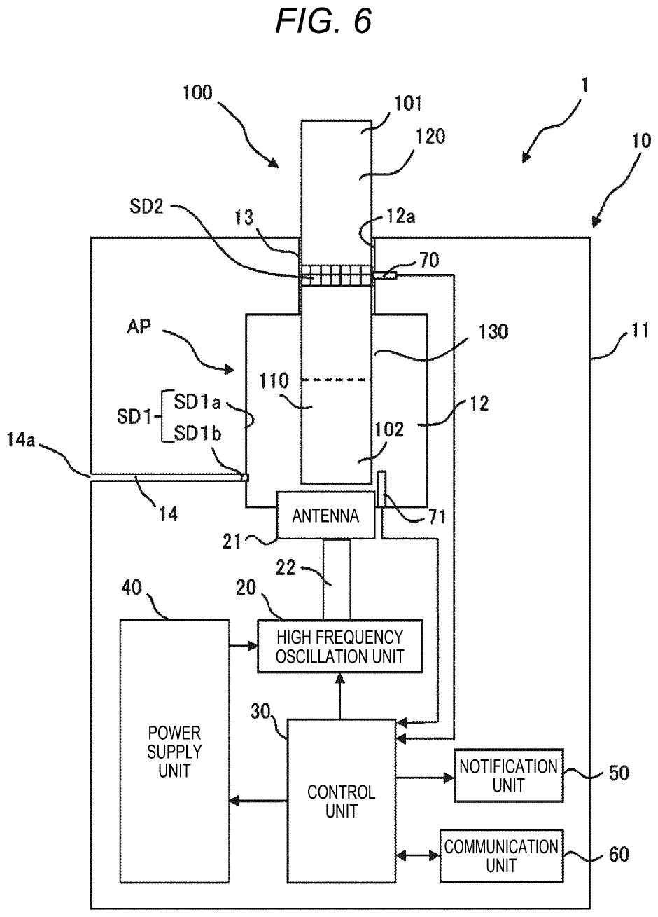

Next, an aerosol generation system 1 according to a second embodiment of the present invention will be described with reference to FIG. 6. The aerosol generation system 1 is the same as the first embodiment except that the flavor inhaler 10 further includes an insertion detection sensor 71 that detects insertion of the tobacco stick 100, and members common to those in the first embodiment are given the same reference numerals and descriptions thereof will be omitted.

The insertion detection sensor 71 is in an ON state when the insertion of the tobacco stick 100 is completed, and is in an OFF state when the tobacco stick 100 is being inserted or when the tobacco stick 100 is detached. The insertion detection sensor 71 is, for example, a capacitive proximity sensor, but is not limited thereto, and a contact sensor such as a pressure sensor, a photoelectric sensor, or the like may be used. Here, the insertion detection sensor 71 corresponds to a “second detection unit” in the present invention.

As shown in FIG. 6, the insertion detection sensor 71 is disposed at a bottom portion of the accommodating portion 12 and detects whether the insertion of the tobacco stick 100 is completed. However, the insertion detection sensor 71 only needs to be able to detect the insertion of the tobacco stick 100, and may be disposed in the guide portion 13 or in the middle of the accommodating portion 12. The detection by the insertion detection sensor 71 is repeatedly executed when the flavor inhaler 10 is in operation.

### (Control of Supply of Microwaves)

Next, the control related to supply of microwaves when the tobacco stick 100 is inserted into the flavor inhaler 10 and when the tobacco stick 100 is detached from the flavor inhaler 10 will be described.

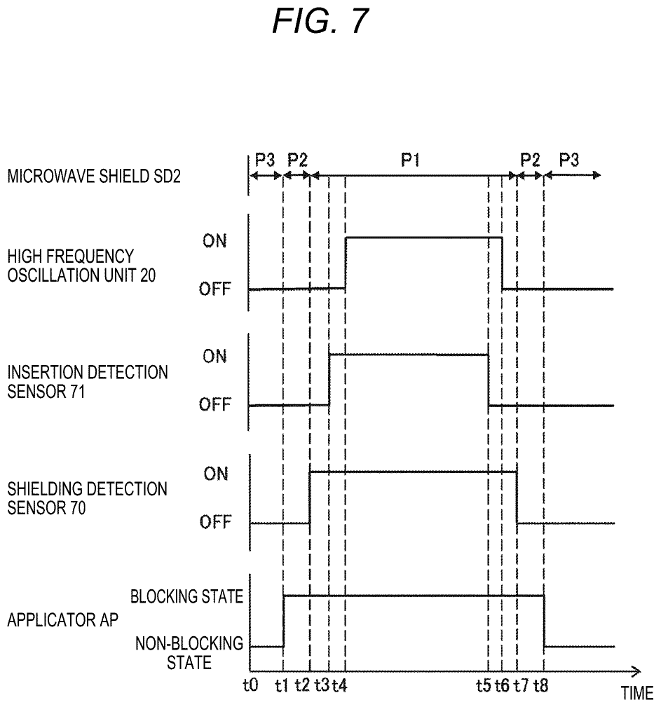

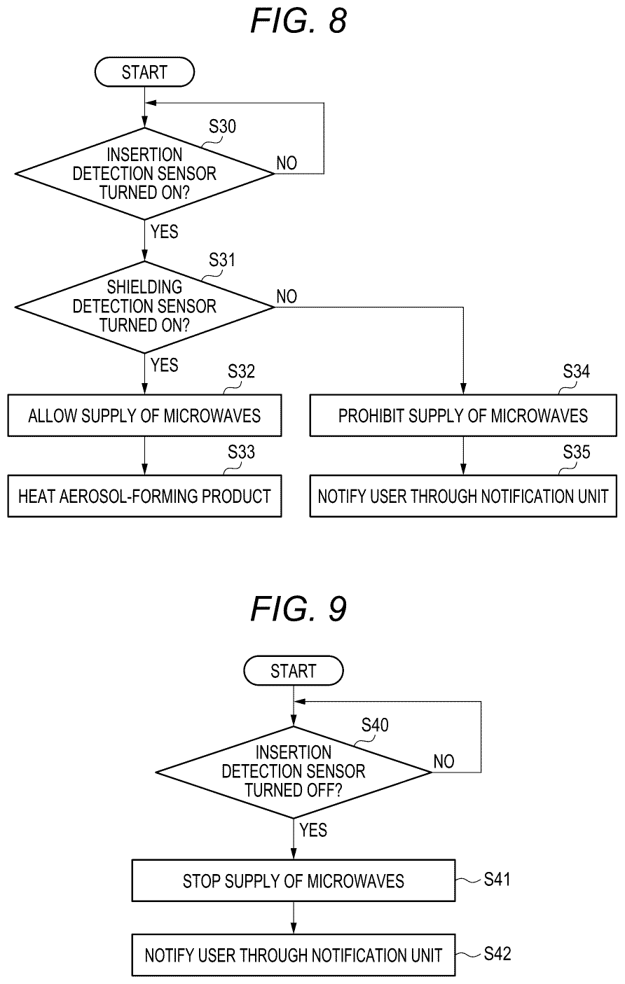

First, with reference to FIGS. 7 and 8, a control flow related to the supply of microwaves when the tobacco stick 100 is inserted into the flavor inhaler 10 will be described.

As shown in FIG. 7, at time to, which is an initial state, a position of the microwave shield SD2 is in the third position P3. At this time, the high frequency oscillation unit 20 is in an OFF state, the insertion detection sensor 71 is in an OFF state, the shielding detection sensor 70 is in an OFF state, and the applicator AP is in the non-blocking state. When the tobacco stick 100 is inserted, the microwave shield SD2 is located at the second position P2 at time t1. At this time, although the applicator AP is in a blocking state, the high frequency oscillation unit 20 is maintained in the OFF state and the shielding detection sensor 70 is maintained in the OFF state. When the tobacco stick 100 is further inserted, the microwave shield SD2 reaches a first position at time t2. At this time, the shielding detection sensor 70 detects that the microwave shield SD2 is disposed at the first position, and the shielding detection sensor 70 is in an ON state. The shielding detection sensor 70 transmits a signal indicating the ON state to the control unit 30. Thereafter, at time t3, the insertion of the tobacco stick 100 is completed. At this time, the insertion detection sensor 71 detects the completion of the insertion of the tobacco stick 100 and is in an ON state. The insertion detection sensor 71 transmits a signal indicating the ON state to the control unit 30. The high frequency oscillation unit 20 is maintained in the OFF state.

At time t4, in response to receiving the signals transmitted from the shielding detection sensor 70 and the insertion detection sensor 71, the control unit 30 switches the high frequency oscillation unit 20 to an ON state to allow the supply of microwaves from the high frequency oscillation unit 20. After time t4, the tobacco stick 100 is heated.

FIG. 8 shows a control flow by the control unit 30. When the tobacco stick 100 is inserted into the flavor inhaler 10, in step S30, the control unit 30 determines whether the insertion detection sensor 71 is in the ON state. When the insertion detection sensor 71 is not in the ON state (NO), the process returns to step S30 again, and the control unit 30 monitors the insertion detection sensor 71 until the insertion detection sensor 71 is in the ON state. When the insertion detection sensor 71 is in the ON state (YES), the process proceeds to step S31. In step S31, the control unit 30 determines whether the shielding detection sensor 70 is in the ON state. When the shielding detection sensor 70 is in the ON state, the process proceeds to step S32. In step S32, the control unit 30 allows the supply of the microwaves from the high frequency oscillation unit 20, and in step S33, the tobacco stick 100 is heated.

In step S33, heating may be started in response to an operation of a user such as pressing a button provided on the flavor inhaler 10, or heating may be automatically started after the end of step S32. In the state of step S30, when an instruction to start heating is given by the operation of the user such as pressing a button, the supply of microwaves is prohibited, and the notification unit 50 notifies the user that heating will not start.

Here, a case where the shielding detection sensor 70 is not in the ON state in step S31 (NO) will be described. The case where the insertion of the tobacco stick 100 is detected (step S30: YES) but the shielding detection sensor 70 is not in the ON state is, for example, a case where an inserted aerosol-forming product does not have the microwave shield SD2. That is, this is a case where a non-genuine aerosol-forming product that is not the flavor inhaler 10 of the present embodiment is inserted. In such a case, the control unit 30 prohibits the supply of microwaves in step S34. Then, in step S35, the notification unit 50 notifies the user that the supply of microwaves is prohibited, that is, the aerosol-forming product will not be heated.

As described above, when the shielding detection sensor 70 detects that the microwave shield SD2 is disposed at the first position and the insertion detection sensor 71 detects the insertion of the tobacco stick 100 into the accommodating portion 12, the control unit 30 allows the supply of the microwaves from the high frequency oscillation unit 20. Therefore, the possibility of microwave leakage to the outside can be reduced.

In the present embodiment, as shown in FIG. 7, although the insertion detection sensor 71 is in the ON state after the shielding detection sensor 70 enters in the ON state, the shielding detection sensor 70 may be configured to be in the ON state at the same time as the insertion detection sensor 71 is in the ON state, or after the insertion detection sensor 71 enters in the ON state.

Next, with reference to FIGS. 7 and 9, a control flow related to the supply of microwaves when the tobacco stick 100 is detached from the flavor inhaler 10 will be described.

After time t4 at which heating of the tobacco stick 100 is executed, the user may pull out the tobacco stick 100. The tobacco stick 100 may be unintentionally detached by the user. In this case, if the supply of microwaves is not prohibited before the applicator AP enters the non-blocking state, the microwaves may leak to the outside of the flavor inhaler 10. Therefore, in the present embodiment, the control unit 30 is configured to prohibit the supply of microwaves in response to the transition of the insertion detection sensor 71 from the ON state to the OFF state.

Specifically, as shown in FIG. 7, at time t5 when the tobacco stick 100 is being heated, detachment of the tobacco stick 100 is started. At this time, although the insertion detection sensor 71 is in the OFF state, the shielding detection sensor 70 is maintained in the ON state and the applicator AP is maintained in the blocking state. When the insertion detection sensor 71 is in the OFF state, the insertion detection sensor 71 no longer transmits the signal indicating the ON state as described above, and the reception of the signal by the control unit 30 is stopped. The high frequency oscillation unit 20 is maintained in the ON state.

When the reception of the signal from the insertion detection sensor 71 is stopped, the control unit 30 switches the high frequency oscillation unit 20 to the OFF state at time t6 before the shielding detection sensor 70 enters the OFF state, and stops the supply of the microwaves from the high frequency oscillation unit 20. Thereafter, at time t7, the microwave shield SD2 is located at a second position. At this time, the shielding detection sensor 70 is in the OFF state. When the shielding detection sensor 70 is in the OFF state, the shielding detection sensor 70 no longer transmits the signal indicating the ON state as described above, and the reception of the signal by the control unit 30 is stopped. After the signal from the shielding detection sensor 70 is cut off, at time t8, the applicator AP transitions from the blocking state to the non-blocking state. At the same time as the signal from the shielding detection sensor 70 is cut off, the applicator AP may transition from the blocking state to the non-blocking state.

FIG. 9 shows a control flow by the control unit 30. During heating by microwaves, in step S40, the control unit 30 determines whether the insertion detection sensor 71 is switched to the OFF state. When the insertion detection sensor 71 is not switched to the OFF state (NO), the process returns to step S40 again, and the control unit 30 monitors the insertion detection sensor 71 until the insertion detection sensor 71 is switched to the OFF state. When the insertion detection sensor 71 is switched to the OFF state (YES), the process proceeds to step S41. In step S41, the control unit 30 stops the supply of the microwaves from the high frequency oscillation unit 20, and the process proceeds to step S42. In step S42, the notification unit 50 notifies the user that the supply of the microwaves is stopped.

In the example shown in FIG. 7, when the tobacco stick 100 is detached, the control unit 30 is configured to stop the supply of the microwaves from the high frequency oscillation unit 20 in response to the insertion detection sensor 71 being switched to the OFF state before the shielding detection sensor 70 being switched to the OFF state. Therefore, the supply of the microwaves can be stopped more quickly than in the case where the supply of the microwaves is stopped in response to the shielding detection sensor 70 being switched to the OFF state.

When the tobacco stick 100 is detached, the signal from the insertion detection sensor 71 may be cut off (OFF state) after the signal from the shielding detection sensor 70 is cut off (OFF state). In this case, after the signal from the insertion detection sensor 71 is cut off, the control unit 30 may stop the supply of the microwaves before the applicator AP enters the non-blocking state.

### <<First Modification>>

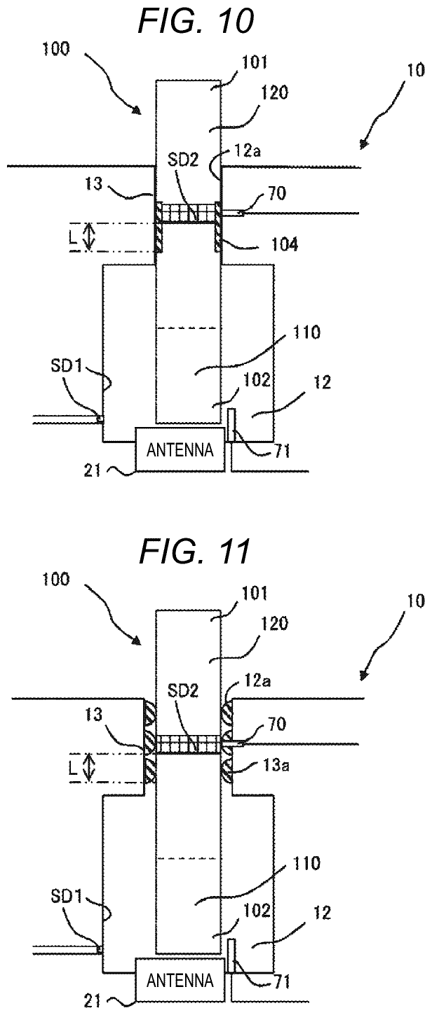

FIG. 10 shows a tobacco stick 100 according to a modification of the present invention.

The tobacco stick 100 is provided with a conductive portion 104 electrically connected to the microwave shield SD2. The conductive portion 104 is formed in an annular shape over an outer periphery of the microwave shield SD2 on an outer peripheral surface of the tobacco stick 100. The conductive portion 104 is formed of, for example, thin foil. Since the conductive portion 104 is electrically connected to the microwave shield SD2, the shielding detection sensor 70 can detect the microwave shield SD2 by detecting the conductive portion 104.

The conductive portion 104 extends from a position of the microwave shield SD2 toward the tobacco rod portion 110 in an axial direction of the tobacco stick 100. This increases the area in which the position of the microwave shield SD2 can be detected. In addition, a temporal difference between the detection by the insertion detection sensor 71 and the detection by the shielding detection sensor 70 in the second embodiment can be increased by a distance L from the microwave shield SD2 to an end of the conductive portion 104 closer to the tobacco rod portion 110. Specifically, in FIG. 7, a temporal difference between the time t5 when the insertion detection sensor 71 is switched to the OFF state and the time t7 when the shielding detection sensor 70 is switched to the OFF state can be increased. The configuration of the tobacco stick 100 is not limited thereto, and as a configuration for increasing the above temporal difference, a configuration in which the microwave shield SD2 is made thicker in the axial direction may be associated with the conductive portion 104.

The conductive portion 104 also has a microwave shielding function. In the process of detaching the tobacco stick 100, even when the microwave shield SD2 is located outside the guide portion 13, a microwave shielding structure is formed by the microwave shield SD2, the conductive portion 104, and the microwave shield SD1. Therefore, the period during which the applicator AP is in the blocking state can be increased.

### <<Second Modification>>

FIG. 11 shows a flavor inhaler 10 which is a modification of the present invention.

A plurality of protrusions 13a are provided on an inner peripheral surface of the guide portion 13 of the flavor inhaler 10 from the opening 12a toward the accommodating portion 12. Each of the protrusions 13a has a semicircular cross section and is provided in an annular shape on the inner peripheral surface of the guide portion 13. In addition, a surface of the plurality of protrusions 13a is made of a material that does not transmit microwaves, and is, for example, a metal layer formed of at least one material selected from the group consisting of aluminum, stainless steel, silver, gold, copper, nickel, chromium, and alloys containing aluminum, stainless steel, silver, gold, copper, nickel, or chromium. This metal layer constitutes the microwave shield SD1. The plurality of protrusions 13a may be metal moldings, and in that case, the plurality of protrusions 13a constitute the microwave shield SD1.

The plurality of protrusions 13a protrude in an axial direction of the guide portion 13 so as to come into contact with the tobacco stick 100. This makes it possible to reduce the insertion resistance when the tobacco stick 100 is inserted into the guide portion 13, as compared with a case where the plurality of protrusions 13a are not provided.

In addition, since the microwave shield SD1 formed by the plurality of protrusions 13a are made of a material having high thermal conductivity such as metal, when the tobacco stick 100 comes into contact with the plurality of protrusions 13a, the smoke passing through the inside of the tobacco stick 100 can be cooled. Such a cooling function is adjusted by adjusting the number of the protrusions 13a and a contact area with the tobacco stick 100.

### <<Configuration of Tobacco Stick>>

Next, with reference to FIGS. 12 and 13, the configuration of the tobacco stick 100 according to the above first embodiment and second embodiment will be described in detail.

As described above, the tobacco stick 100 includes the tobacco rod portion 110, the mouthpiece portion (mouthpiece) 120, the tipping paper 130, and the microwave shield SD2. In the example shown in FIGS. 12 and 13, the tobacco stick 100 has a substantially constant diameter over the entire length in a longitudinal direction (hereinafter, also referred to as an axial direction or a Z direction) from the mouthpiece 101 to the tip 102. An X direction and a Y direction in FIGS. 12 and 13 are directions orthogonal to the Z direction.

### <Tipping Paper>

The material of the tipping paper 130 is not particularly limited, and it is possible to use paper made of general vegetable fibers (pulp), a sheet using polymer-based (polypropylene, polyethylene, nylon, or the like) chemical fibers, a polymer-based sheet, metal foil, or a composite material obtained by combining the paper made of general vegetable fibers, the sheet using polymer-based chemical fibers, the polymer-based sheet, or the metal foil. For example, the tipping paper 130 may be made of a composite material in which a polymer-based sheet is attached to a paper base material. The tipping paper 130 referred to here means a sheet-shaped material that connects a plurality of segments on the tobacco stick 100, such as connecting the tobacco rod portion 110 and the mouthpiece portion 120.

Although a basis weight of the tipping paper 130 is not particularly limited, the basis weight is usually 32 gsm or more and 40 gsm or less, preferably 33 gsm or more and 39 gsm or less, and more preferably 34 gsm or more and 38 gsm or less. Although air permeability of the tipping paper 130 is not particularly limited, the air permeability is usually 0 Coresta units or more and 30000 Coresta units or less, and preferably more than 0 Coresta units and 10000 Coresta units or less. The air permeability is a value measured in accordance with ISO 2965:2009, and is represented by a flow rate (cm³) of gas passing through an area of 1 cm² every minute when a differential pressure between both surfaces of the paper is 1 kPa. One Coresta unit (one Coresta unit, 1 C.U.) is cm³/(min cm²) under 1 kPa.

The tipping paper 130 may contain a filler in addition to the above pulp, and examples thereof include metal carbonates such as calcium carbonate and magnesium carbonate, metal oxides such as titanium oxide, titanium dioxide, and aluminum oxide, metal sulfate such as barium sulfate and calcium sulfate, metal sulfides such as zinc sulfide, quartz, kaolin, talc, diatomaceous earth, and gypsum, and particularly preferably contains calcium carbonate from the viewpoint of improving whiteness and opacity and increasing heating rate. These fillers may be used alone or in combination of two or more.

In addition to the above pulp and fillers, the tipping paper 130 may contain various auxiliary agents, for example, in order to improve water resistance, the tipping paper 130 may have a water resistance improver. The water resistance improver includes a wet strength agent (WS agent) and a sizing agent. Examples of the wet strength agent include urea formaldehyde resin, melamine formaldehyde resin, and polyamide epichlorohydrin (PAE). Examples of the sizing agent include rosin soap, alkyl ketene dimer (AKD), alkenyl succinic anhydride (ASA), and highly saponified polyvinyl alcohol having a saponification degree of 90% or more.

A coating agent may be added to at least one of two surfaces of a front surface and a back surface of the tipping paper 130. The coating agent is not particularly limited, and a coating agent capable of forming a film on surfaces of paper to reduce liquid permeability is preferable.

A manufacturing method of the tipping paper 130 is not particularly limited, and a general method can be applied. For example, in a case of an aspect in which pulp is a main component, the manufacturing method includes a method in which during a paper making process using pulp to prepare paper using a Fourdrinier paper machine, a cylinder paper machine, a cylinder and Tanmo composite paper machine, and the like, the formation of the paper is adjusted and homogenized. If necessary, the wet strength agent may be added to impart water resistance to rolling paper, or the sizing agent may be added to adjust the printing quality of the rolling paper.

### <Tobacco Rod Portion>

The configuration of the tobacco rod portion 110 is not particularly limited, and may be a general configuration. For example, it is possible to use a tobacco rod portion in which a tobacco filler 111 is wrapped with rolling paper 112.

### [Tobacco Filler]

The tobacco filler 111 includes, for example, tobacco leaves, tobacco leaf extract, and processed products thereof as flavor sources. In the present embodiment, the tobacco filler 111 includes shredded tobacco. The material of the shredded tobacco contained in the tobacco filler 111 is not particularly limited, and known materials such as laminas or stems can be used. The material may be made by crushing dried tobacco leaves to have an average particle size of 20 μm or more and 200 μm or less to obtain a crushed tobacco product, and processing the homogenized crushed tobacco product into a sheet (hereinafter, also simply referred to as a homogenized sheet), which is then shredded. Further, the material may be a strand type material in which a tobacco rod is filled with a homogenized sheet having a length substantially equal to that in a longitudinal direction of the tobacco rod, which is shredded approximately horizontally to the longitudinal direction of the tobacco rod. In addition, a width of the shredded tobacco is preferably 0.5 mm or more and 2.0 mm or less for filling the tobacco rod portion 110. The content of the dried tobacco leaves contained in the tobacco rod portion 110 is not particularly limited, but may be 200 mg/rod portion or more and 800 mg/rod portion or less, and is preferably 250 mg/rod portion or more and 600 mg/rod portion or less. This range is particularly suitable for the tobacco rod portion 110 having a circumference of 22 mm and a length of 20 mm.

Various types of tobacco can be used for the tobacco leaves used for producing the shredded tobacco and the homogenized sheet. Examples thereof include yellow varieties, burley varieties, orient varieties, native varieties, other Nicotiana tabacum varieties, Nicotiana rustica varieties, and mixtures thereof. The mixtures can be used by appropriately blending the above various varieties so as to obtain a desired taste. Details of the varieties of tobacco are disclosed in “Tobacco Encyclopedia, Tobacco Academic Studies Center, 2009. 3. 31”. There are a plurality of methods in the related art for manufacturing the above homogenized sheet, that is, methods for crushing tobacco leaves and processing the crushed tobacco leaves into a homogenized sheet. The first method is a method for producing a paper sheet using a paper making process. The second method is a method in which an appropriate solvent, such as water, is mixed with crushed tobacco leaves, the mixture is homogenized, and then the homogenized product is thinly cast onto a metal plate or metal plate belt and dried to produce a cast sheet. The third method is a method for preparing a rolled sheet by mixing an appropriate solvent such as water with crushed tobacco leaves, homogenizing the mixture, and extruding the mixture into a sheet. Details of types of the homogenized sheet are disclosed in “Tobacco Encyclopedia, Tobacco Academic Studies Center, 2009. 3. 31”.

A moisture content of the tobacco filler 111 is, for example, 10% by weight or more and 15% by weight or less with respect to a total amount of the tobacco filler 111, and is preferably 11% by weight or more and 13% by weight or less. When the moisture content is in such a range, wrapping stains are reduced, and the wrapping suitability during manufacturing of the tobacco rod portion 110 is improved. The size of the shredded tobacco contained in the tobacco filler 111 and the preparation method thereof are not particularly limited. For example, dried tobacco leaves may be shredded to have a width of 0.5 mm or more and 2.0 mm or less. In addition, when a crushed homogenized sheet is used, dried tobacco leaves may be crushed and homogenized to have an average particle size of about 20 m to 200 μm, the homogenized product may be processed into a sheet, and then the sheet is shredded to have a width of 0.5 mm or more and 2.0 mm or less.

The tobacco filler 111 contains an aerosol base material that generates aerosol smoke. The type of the aerosol base material is not particularly limited, and extract substances from various natural products and/or constituent components thereof can be selected according to the application. Examples of the aerosol base material include glycerin, propylene glycol, triacetin, 1,3-butanediol, and mixtures thereof. Although the content of the aerosol base material in the tobacco filler 111 is not particularly limited, the content is usually 5% by weight or more, preferably 10% by weight or more, and usually 50% by weight or less, preferably 15% by weight or more and 25% by weight or less, with respect to the total amount of the tobacco filler, from the viewpoint of generating sufficient aerosol and imparting good flavor.

The tobacco filler 111 may contain a fragrance. The type of the fragrance is not particularly limited, and from the viewpoint of imparting good flavor, examples of the fragrance include acetanisole, acetophenone, acetylpyrazine, 2-acetylthiazole, alfalfa extract, amyl alcohol, amyl butyrate, trans-anethole, star anise oil, apple juice, balsam Peru oil, beeswax absolute, benzaldehyde, benzoin resinoid, benzyl alcohol, benzyl benzoate, benzyl phenylacetate, benzyl propionate, 2,3-butanedione, 2-butanol, butyl butyrate, butyric acid, caramel, cardamom oil, carob absolute, β-carotene, carrot juice, L-carvone, β-caryophyllene, Cassia bark oil, cedarwood oil, celery seed oil, chamomile oil, cinnamaldehyde, cinnamic acid, cinnamyl alcohol, cinnamyl cinnamate, citronella oil, DL-citronellol, clary sage extract, cocoa, coffee, cognac oil, coriander oil, cuminaldehyde, davana oil, δ-decalactone, γ-decalactone, decanoic acid, dillherb oil, 3,4-dimethyl-1,2-cyclopentanedione, 4,5-dimethyl-3-hydroxy-2,5-dihydrofuran-2-one, 3,7-dimethyl-6-octenoic acid, 2,3-dimethylpyrazine, 2,5-dimethylpyrazine, 2,6-dimethylpyrazine, ethyl 2-methylbutyrate, ethyl acetate, ethyl butyrate, ethyl hexanoate, ethyl isovalerate, ethyl lactate, ethyl laurate, ethyl levulinate, ethyl maltol, ethyl octanoate, ethyl oleate, ethyl palmitate, ethyl phenylacetate, ethyl propionate, ethyl stearate, ethyl valerate, ethyl vanillin, ethyl vanillin glucoside, 2-ethyl-3,(5 or 6)-dimethylpyrazine, 5-ethyl-3-hydroxy-4-methyl-2(5H)-furanone, 2-ethyl-3-methylpyrazine, eucalyptol, fenugreek absolute, gene absolute, gentian root infusion, geraniol, geranyl acetate, grape juice, guaiacol, guava extract, γ-heptalactone, γ-hexalactone, hexanoic acid, cis-3-hexen-1-ol, hexyl acetate, hexyl alcohol, hexyl phenylacetate, honey, 4-hydroxy-3-pentenoic acid lactone, 4-hydroxy-4-(3-hydroxy-1-butenyl)-3,5,5-trimethyl-2-cyclohexen-1-one, 4-(para-hydroxyphenyl)-2-butanone, sodium 4-hydroxyundecanoate, inmoltel absolute, β-ionone, isoamyl acetate, isoamyl butyrate, isoamyl phenylacetate, isobutyl acetate, isobutyl phenylacetate, jasmine absolute, kola nut tincture, labdanum oil, lemon terpeneless oil, licorice extract, linalool, linalyl acetate, lovage root oil, maltol, maple syrup, menthol, menthone, L-menthyl acetate, paramethoxybenzaldehyde, methyl-2-pyrrolyl ketone, methyl anthranilate, methyl phenylacetate, methyl salicylate, 4′-methylacetophenone, methylcyclopentenolone, 3-methylvaleric acid, Mimosa absolute, molasses, myristic acid, nerol, nerolidol, γ-nonalactone, nutmeg oil, δ-octalactone, octanal, octanoic acid, orange flower oil, orange oil, orris root oil, palmitic acid, ω-pentadecalactone, peppermint oil, petitgrain Paraguayan oil, phenethyl alcohol, phenethyl phenylacetate, phenylacetic acid, piperonal, plum extract, propenylguaetol, propyl acetate, 3-propylidenephthalide, prune juice, pyruvic acid, raisin extract, rose oil, rum, sage oil, sandalwood oil, spearmint oil, Styrax absolute, marigold oil, tea distillate, α-terpineol, terpinyl acetate, 5,6,7,8-tetrahydroquinoxaline, 1,5,5,9-tetramethyl-13-oxacyclo(8.3.0.0(4.9))tridecane, 2,3,5,6-tetramethylpyrazine, thyme oil, tomato extract, 2-tridecanone, triethyl citrate, 4-(2,6,6-trimethyl-1-cyclohexenyl)2-buten-4-one, 2,6,6-trimethyl-2-cyclohexene-1,4-dione, 4-(2,6,6-trimethyl-1,3-cyclohexadienyl)2-buten-4-one, 2,3,5-trimethylpyrazine, γ-undecalactone, γ-valerolactone, vanilla extract, vanillin, veratraldehyde, violet leaf absolute, N-ethyl-p-menthane-3-carboxamide (WS-3), and ethyl-2-(p-menthane-3-carboxamide) acetate (WS-5), and menthol is particularly preferred. These fragrances may be used alone or in combination of two or more.

Although the content of the fragrance in the tobacco filler 111 is not particularly limited, the content is usually 10000 ppm or more, preferably 20000 ppm or more, more preferably 25000 ppm or more, and usually 70000 ppm or less, preferably 50000 ppm or less, more preferably 40000 ppm or less, and still more preferably 33000 ppm or less, from the viewpoint of imparting good flavor.

### [Rolling Paper]

The rolling paper 112 is a sheet material for wrapping the tobacco filler 111. The configuration of the rolling paper 112 is not particularly limited, and a general rolling paper can be used. For example, cellulose fiber paper can be used as the base paper used for the rolling paper 112, and more specifically, hemp, wood, or a mixture thereof can be used. A basis weight of the base paper of the rolling paper 112 is usually 20 gsm or more, and preferably 25 gsm or more. Meanwhile, the basis weight is usually 65 gsm or less, preferably 50 gsm or less, and more preferably 45 gsm or less. A thickness of the rolling paper 112 having the above characteristics is not particularly limited, and the thickness is usually 10 μm or more, preferably 20 μm or more, more preferably 30 μm or more, and usually 100 μm or less, preferably 75 μm or less, and more preferably 50 μm or less, from the viewpoint of rigidity, air permeability, and ease of adjustment during papermaking.

The rolling paper 112 of the tobacco rod portion 110 (tobacco filler 111) may have a square shape or rectangular shape. When the paper is used as the rolling paper 112 for wrapping the tobacco filler 111 (for producing the tobacco rod portion 110), a length of one side may be about 6 mm to 70 mm, a length of the other side may be about 15 mm to 28 mm, a preferable length of the other side may be about 22 mm to 24 mm, and a more preferable length may be about 23 mm.

In addition to the above pulp, the rolling paper 112 may contain a filler. The content of the filler may be 10% by weight or more and less than 60% by weight, preferably 15% by weight or more and 45% by weight or less, with respect to the total weight of the rolling paper 112. In the rolling paper 112, the filler is preferably 15% by weight or more and 45% by weight or less within a preferable basis weight range (25 gsm or more and 45 gsm or less). Further, when the basis weight is 25 gsm or more and 35 gsm or less, the filler is preferably 15% by weight or more and 45% by weight or less, and when the basis weight is more than 35 gsm and 45 gsm or less, the filler is preferably 25% by weight or more and 45% by weight or less. Calcium carbonate, titanium dioxide, kaolin and the like can be used as the filler, and the calcium carbonate is preferably used from the viewpoint of increasing flavor and whiteness.

Various auxiliary agents other than the base paper and the filler may be added to the rolling paper 112. For example, in order to improve water resistance, a water resistance improver may be added. The water resistance improver includes a wet strength agent (WS agent) and a sizing agent. Examples of the wet strength agent include urea formaldehyde resin, melamine formaldehyde resin, and polyamide epichlorohydrin (PAE). Examples of the sizing agent include rosin soap, alkyl ketene dimer (AKD), alkenyl succinic anhydride (ASA), and highly saponified polyvinyl alcohol having a saponification degree of 90% or more. A paper strength agent may be added as an auxiliary agent, and examples thereof include polyacrylamide, cationic starch, oxidized starch, CMC, polyamide epichlorohydrin resin, and polyvinyl alcohol. In particular, it is known that using a very small amount of oxidized starch improves the air permeability (for example, JP2017-218699A). The rolling paper 112 may be appropriately coated.

A coating agent may be added to at least one of two surfaces of a front surface and a back surface of the rolling paper 112. The coating agent is not particularly limited, and a coating agent capable of forming a film on surfaces of paper to reduce liquid permeability is preferable. Examples thereof include alginic acid and salts thereof (for example, sodium salt), polysaccharides such as pectin, cellulose derivatives such as ethyl cellulose, methyl cellulose, carboxy methyl cellulose, and nitrocellulose, and starch and derivatives thereof (for example, ether derivatives such as carboxymethyl starch, hydroxyalkyl starch, and cationic starch, and ester derivatives such as starch acetate, starch phosphate, and starch octenyl succinate).

An axial length of the tobacco rod portion 110 may be appropriately changed according to a size of a product, and is, for example, 5 mm or more, preferably 10 mm or more, more preferably 12 mm or more, still more preferably 18 mm or more, and usually 70 mm or less, preferably 50 mm or less, more preferably 30 mm or less, and still more preferably 25 mm or less.

### <Mouthpiece Portion>

The configuration of the tobacco stick 100 is not particularly limited, and may be a general configuration. In the aspect shown in FIGS. 12 and 13, the mouthpiece portion 120 includes two segments (sections), that is, a cooling segment 121 and a filter segment 122. The cooling segment 121 is disposed in contact with the tobacco rod portion 110 and the filter segment 122 and is sandwiched therebetween. In other embodiments, a gap may be formed between the tobacco rod portion 110 and the cooling segment 121 and between the tobacco rod portion 110 and the filter segment 122. The mouthpiece portion 120 may be formed of a single segment.

### [Cooling Segment]

The configuration of the cooling segment 121 is not particularly limited as long as the cooling segment 121 has a function of cooling mainstream tobacco smoke, for example, the cooling segment 121 may be made of cardboard processed into a cylindrical shape. In this case, the inside of the cylindrical shape is hollow, and vapor containing the aerosol base material and a tobacco flavor component is cooled by coming into contact with the air within the hollow.

One aspect of the cooling segment 121 may be a paper tube obtained by processing one paper sheet or a plurality of paper sheets laminated together into a cylindrical shape. In order to bring room temperature external air into contact with high-temperature vapor to improve a cooling effect, it is preferable that holes for introducing the external air be provided around the paper tube. The cooling segment 121 is provided with ventilation holes 103, which are holes for taking in the external air. The number of the ventilation holes 103 in the cooling segment 121 is not particularly limited. In the present embodiment, the plurality of ventilation holes 103 are disposed at regular intervals in a circumferential direction of the cooling segment 121. The group of ventilation holes 103 disposed in the circumferential direction of the cooling segment 121 may be formed in multiple stages along an axial direction of the cooling segment 121. When the cooling segment 121 is provided with the ventilation holes 103, low-temperature air flows into the cooling segment 121 from the outside when the tobacco stick 100 is suctioned, and the temperature of volatile components or the air flowing from the tobacco rod portion 110 can be lowered. In addition, the vapor containing the aerosol base material and the tobacco flavor component is condensed by being cooled by the low-temperature air introduced into the cooling segment 121 through the ventilation holes 103. Thus, the generation of aerosol is promoted, and sizes of aerosol particles can be controlled. By coating an inner surface of a paper tube with a polymer such as polyvinyl alcohol or with a polysaccharide such as pectin, the cooling effect can be improved by utilizing heat absorption of the coating and heat of dissolution due to phase change. The ventilation resistance of the cylindrical cooling segment is 0 mmH₂O.

When the cooling segment 121 is filled with a sheet or the like for cooling the volatile component or air flowing into the cooling segment 121 from the tobacco rod portion 110, a total surface area of the cooling segment 121 is not particularly limited, and may be, for example, 300 mm²/mm or more and 1000 mm²/mm or less. The surface area is a surface area per length (mm) of the cooling segment 121 in a ventilation direction. The total surface area of the cooling segment 121 is preferably 400 mm²/mm or more, more preferably 450 mm²/mm or more, is preferably 600 mm²/mm or less, and more preferably 550 mm²/mm or less.

In the cooling segment 121, internal structures thereof preferably have a large total surface area. Therefore, in a preferred embodiment, the cooling segment 121 may be formed of a sheet of a thin material that is wrinkled and then pleated, gathered, and folded to form channels. When there are many folds or pleats within a given volume of elements, the total surface area of the cooling segments 121 increases. A thickness of the constituent material of the cooling segment 121 is not particularly limited, and may be, for example, 5 μm or more and 500 μm or less, and may be 10 μm or more and 250 μm or less.

It is also desirable to use paper as a material of a cooling sheet member from the viewpoint of reducing environmental load. It is desirable that the paper as the material for the cooling sheet has a basis weight of 30 g/m² to 100 g/m² and a thickness of 20 μm to 100 μm. From the viewpoint of reducing the removal of flavor source components and the aerosol base material component in the cooling segment, the air permeability of the paper as the material for the cooling sheet is preferably low, and the air permeability is preferably 10 Coresta units or less. By coating the paper as the material for the cooling sheet with a polymer such as polyvinyl alcohol or with a polysaccharide such as pectin, the cooling effect can be improved by utilizing heat absorption of the coating and heat of dissolution due to phase change.

The ventilation holes 103 in the cooling segment 121 are preferably disposed at positions separated from a boundary between the cooling segment 121 and the filter segment 122 by 4 mm or more. Thus, not only the cooling capacity of the cooling segment 121 can be improved, but also retention of a component generated by heating in the cooling segment 121 can be reduced, and a delivery amount of the component can be improved. It is preferable that the tipping paper 130 is provided with holes at positions (positions that vertically overlap) directly above the ventilation holes 103 provided in the cooling segment 121. The holes of the cooling segment 121 are preferably provided such that an air inflow ratio from the holes when the air is suctioned at 17.5 ml/sec by an automatic smoking machine (a volume ratio of the air flowing in from the holes when a ratio of the air suctioned from the mouthpiece is 100% by volume) is 10% to 90% by volume, preferably 50% to 80% by volume, and more preferably 55% to 75% by volume, and can be achieved by, for example, selecting the number of holes V per hole group from a range of 5 to 50, selecting a diameter of each of the holes V from a range of 0.1 mm to 0.5 mm, and combining these selections. The above air inflow ratio can be measured by a method according to ISO9512 using an automatic smoking machine (for example, a single-stick automatic smoking machine manufactured by Borgwaldt). Although a length of the cooling segment 121 in the axial direction (ventilation direction) is not particularly limited, the length is usually 10 mm or more, preferably 15 mm or more, and usually 40 mm or less, preferably 35 mm or less, and more preferably 30 mm or less. The length of the cooling segment 121 in the axial direction is particularly preferably 20 mm. By setting the axial length of the cooling segment 121 to be equal to or greater than the above lower limit, a sufficient cooling effect can be ensured and a good flavor can be obtained. In addition, by setting the axial length of the cooling segment 121 to be equal to or less than the above upper limit, loss caused by vapor and aerosol generated during use adhering to an inner wall of the cooling segment 121 can be reduced.

### [Filter Segment]

The configuration of the filter segment 122 is not particularly limited as long as the filter segment 122 has a function as a general filter, and for example, the filter segment 122 may be formed by processing cellulose acetate tow into a cylindrical shape. Although the single yarn fineness and total fineness of the cellulose acetate tow are not particularly limited, when the filter segment 122 has a circumference of 22 mm, the single yarn fineness is preferably 5 g/9000 m to 20 g/9000 m, and the total fineness is 12000 g/9000 m to 30000 g/9000 m. Fibers of the cellulose acetate tow may have a Y cross-sectional shape or an R cross-sectional shape. When the cellulose acetate tow is filled to form the filter segment 122, triacetin may be added in an amount of 5% to 10% by weight based on the weight of the cellulose acetate tow to improve filter hardness. In the example shown in FIG. 12, the filter segment 122 includes a single segment, but the filter segment 122 may include a plurality of segments. When the filter segment 122 includes a plurality of segments, for example, an aspect may be mentioned in which a hollow segment such as a center hole is disposed on an upstream side (a side closer to the tobacco rod portion 110), and an acetate filter having a mouthpiece cross section filled with the cellulose acetate tow is disposed as a segment on a downstream side (a side closer to the mouthpiece 101). According to this aspect, unnecessary loss of the generated aerosol can be prevented, and the appearance of the tobacco stick 100 can be improved. From the viewpoint of in the sensation of suction response and comfort in the mouth, an acetate filter may be disposed on the upstream side (the side closer to the tobacco rod portion 110), and a hollow segment such as a center hole may be disposed on the downstream side (the side closer to the mouthpiece 101). In addition, the filter segment 122 may use another alternative filter material such as a paper filter filled with sheet-shaped pulp paper instead of the acetate filter.

Examples of a general function of the filter in the filter segment 122 include adjusting the amount of air mixed when the aerosol or the like is suctioned, reducing the flavor, and reducing nicotine and tar. However, the filter does not need to have all of these functions. In an electrically heated tobacco product that produces fewer components and has a lower filling rate of a tobacco filler as compared with a paper tobacco product, another important function is to prevent the falling of the tobacco filler when reducing the filtering function.

Although a cross-sectional shape of the filter segment 122 is substantially circular, and a diameter of the circle can be appropriately changed according to a size of a product, the diameter is usually 4.0 mm or more and 9.0 mm or less, preferably 4.5 mm or more and 8.5 mm or less, and more preferably 5.0 mm or more and 8.0 mm or less. In a case where the cross section is not circular, when the above diameter is assumed to be a circle having the same area as the cross section, the diameter of the circle is applied. Although a circumferential length of the filter segment 122 may be appropriately changed according to a size of a product, the circumferential length is usually 14.0 mm or more and 27.0 mm or less, preferably 15.0 mm or more and 26.0 mm or less, and more preferably 16.0 mm or more and 25.0 mm or less. Although a length of the filter segment 122 in an axial direction may be appropriately changed according to a size of a product, the length is usually 5 mm or more and 35 mm or less, and preferably 10.0 mm or more and 30.0 mm or less. The shape and dimensions of a filter medium can be appropriately adjusted such that the shape and dimensions of the filter segment 122 fall within the above ranges.

Although ventilation resistance per axial length of 120 mm of the filter segment 122 is not particularly limited, the ventilation resistance is usually 40 mmH₂O or more and 300 mmH₂O or less, preferably 70 mmH₂O or more and 280 mmH₂O or less, and more preferably 90 mmH₂O or more and 260 mmH₂O or less. The above ventilation resistance is measured according to the ISO standard method (ISO 6565) using, for example, a filter ventilation resistance measuring device manufactured by Cerulean Corporation. The ventilation resistance of the filter segment 122 refers to an air pressure difference between one end surface (a first end surface) and the other end surface (a second end surface) when air at a predetermined air flow rate (17.5 cc/min) flows from the first end surface to the second end surface in a state where no air permeates through side surfaces of the filter segment 122. The unit of the ventilation resistance can be generally expressed by mmH₂O. It is known that a relation between the ventilation resistance of the filter segment 122 and the length of the filter segment 122 is proportional within a length range (a length of 5 mm to 200 mm) which is usually used, and when the length of the filter segment 122 is doubled, the ventilation resistance is also doubled.

Although the density of the filter medium in the filter segment 122 is not particularly limited, the density is usually 0.10 g/cm³ or more and 0.25 g/cm³ or less, preferably 0.11 g/cm³ or more and 0.24 g/cm³ or less, and more preferably 0.12 g/cm³ or more and 0.23 g/cm³ or less. The filter segment 122 may include rolling paper (filter plug rolling paper) around which a filter medium or the like is wound from the viewpoint of improving strength and structural rigidity. The form of the rolling paper is not particularly limited, and may include one or more rows of joints containing an adhesive. The adhesive may include a hot melt adhesive, and the hot melt adhesive may further include polyvinyl alcohol. When the filter segment 122 includes two or more segments, it is preferable that the two or more of segments are wound together in the rolling paper. The material of the rolling paper in the filter segment 122 is not particularly limited, and a known material can be used. A filler such as calcium carbonate may be contained.

A thickness of the rolling paper is not particularly limited, and is usually 20 μm or more and 140 μm or less, preferably 30 μm or more and 130 μm or less, and more preferably m or more and 120 μm or less. The basis weight of the rolling paper is not particularly limited, and is usually 20 gsm or more and 100 gsm or less, preferably 22 gsm or more and 95 gsm or less, and more preferably 23 gsm or more and 90 gsm or less. The rolling paper may or may not be coated, but is preferably coated with a desired material from the viewpoint of being able to impart functions other than strength and structural rigidity.

When the filter segment 122 includes a center hole segment and a filter medium, the center hole segment and the filter medium may be connected by, for example, an outer plug wrapper (outer rolling paper). The outer plug wrapper may be, for example, cylindrical shaped paper. The tobacco rod portion 110, the cooling segment 121, and the connected center hole segment and filter medium may be connected by, for example, mouthpiece lining paper. These connections can be made by, for example, applying a glue such as a vinyl acetate-based glue to an inner side surface of the mouthpiece lining paper, and inserting and wrapping the tobacco rod portion 110, the cooling segment 121, and the connected center hole segment and filter medium. The tobacco rod portion 110, the cooling segment 121, and the connected center hole segment and filter medium may be connected by a plurality of pieces of lining paper.

The filter medium of the filter segment 122 may include a breakable additive releasing container (for example, a capsule) that includes a breakable shell, such as gelatin. The form of the capsule (also referred to as an “additive releasing container” in the technical field) is not particularly limited, and any known form may be adopted. For example, a breakable additive releasing container that includes a breakable shell such as gelatin may be adopted. The form of the capsule is not particularly limited, and may be, for example, an easy-to-break capsule, and a shape thereof is preferably a sphere. An additive contained in the capsule may contain any of the above additives, and is particularly preferable to contain a flavoring agent or active carbon. In addition, one or more materials may be added as additives to help filter smoke. Although the form of the additive is not particularly limited, the additive is usually liquid or solid. The use of a capsule containing an additive is well known in the present technical field. An easy-to-break capsule and a method for producing the capsule are well known in the present technical field.

The flavoring agent may be, for example, menthol, spearmint, peppermint, fenugreek, clove, medium chain triglycerides (MCT), or a combination thereof. The flavoring agent of the present embodiment is menthol.

A fragrance may be added to the filter medium of the filter segment 122. When a fragrance is added to the filter medium, a delivery amount of the fragrance during use is increased as compared with the related art in which a fragrance is added to the tobacco filler constituting the tobacco rod portion 110. The degree of increase in the delivery amount of the fragrance further increases according to the positions of the holes provided in the cooling segment 121. The method of adding the fragrance to the filter medium is not particularly limited, and the fragrance may be added so as to be substantially uniformly dispersed in the filter medium to which the fragrance is to be added. An addition amount of the fragrance may include an aspect in which the fragrance is added to 10% to 100% by volume of the filter medium. As the addition method, the fragrance may be added to the filter medium in advance before constituting the filter segment, or may be added after constituting the filter segment. Although a type of the fragrance is not particularly limited, the same fragrances as those contained in the above tobacco filler 111 may be used.

The filter segment 122 includes a filter medium, and active carbon may be added to at least a part of the filter medium. An addition amount of the active carbon to the filter medium may be 15.0 m²/cm² or more and 80.0 m²/cm² or less in terms of a value of specific surface area of active carbon×weight of active carbon/cross-sectional area of filter medium in vertical direction with respect to ventilation direction in one tobacco stick 100. The “specific surface area of active carbon×weight of active carbon/cross-sectional area of filter medium in vertical direction with respect to ventilation direction” may be expressed as “surface area of active carbon per unit cross-sectional area” for convenience. The surface area of the active carbon per unit cross-sectional area can be calculated based on the specific surface area of the active carbon added to the filter medium included in one tobacco stick 100, the weight of the added active carbon, and the cross-sectional area of the filter medium. The active carbon may not be uniformly dispersed in the filter medium to which the active carbon is added, and does not need to satisfy the above ranges in all the cross sections (cross sections in a direction perpendicular to the ventilation direction) of the filter medium.

The surface area of the active carbon per unit cross-sectional area is more preferably 17.0 m²/cm² or more, and still more preferably 35.0 m²/cm² or more. On the other hand, the surface area is more preferably 77.0 m²/cm² or less, and still more preferably 73.0 m²/cm² or less. The surface area of the active carbon per unit cross-sectional area can be adjusted by, for example, adjusting the specific surface area of the active carbon, the addition amount thereof, and the cross-sectional area in the direction perpendicular to the ventilation direction of the filter medium. The above surface area of the active carbon per unit cross-sectional area is calculated based on the filter medium to which the active carbon is added. When the filter segment 122 includes a plurality of filter media, the cross-sectional area and the length of only the filter medium to which the active carbon is added are used as references.

As the active carbon, for example, wood, bamboo, coconut shells, walnut shells, coal, or the like can be used as a raw material. As the active carbon, those having a BET specific surface area of 1100 m²/g or more and 1600 m²/g or less, preferably 1200 m²/g or more and 1500 m²/g or less, more preferably 1250 m²/g or more and 1380 m²/g or less can be used. The BET specific surface area can be determined by a nitrogen gas adsorption method (BET multi-point method). As the active carbon, those having a pore volume of 400 μL/g or more and 800 μL/g or less, more preferably 500 μL/g or more and 750 μL/g or less, still more preferably 600 μL/g or more and 700 μL/g or less can be used. The pore volume can be calculated based on a maximum adsorption amount obtained using the nitrogen gas adsorption method. The addition amount of the active carbon per unit length in the ventilation direction of the filter medium to which the active carbon is added is preferably 5 mg/cm or more and 50 mg/cm or less, more preferably 8 mg/cm or more and 40 mg/cm or less, and still more preferably 10 mg/cm or more and 35 mg/cm or less. When the specific surface area of the active carbon and the addition amount of the active carbon are in the above ranges, the surface area of the active carbon per unit cross-sectional area can be adjusted to a desired value.

In the active carbon, a cumulative particle size of 10% by volume (D10 particle size) of active carbon particles is preferably 250 μm or more and 1200 μm or less. A cumulative particle size of 50% by volume (D50 particle size) of active carbon particles is preferably 350 μm or more and 1500 μm or less. The D10 and D50 particle sizes can be measured by a laser diffraction scattering method. As a device suitable for this measurement, a laser diffraction-scattering type particle size distribution measuring device “LA-950” of HORIBA, Ltd. can be used. Powder is poured into a cell of this device together with pure water, and the particle size is detected based on light scattering information of the particles.
Measurement conditions according to the measurement device are as follows.
Measurement mode: manual flow mode cell measurement
Dispersion medium: ion-exchanged water
Dispersion method: particle size is measured after ultrasonic irradiation for 1 minute
Refractive index: 1.92 to 0.00i (refractive index of sample)/1.33 to 0.00i (refractive index of dispersion medium)
Number of measurements: particle size is measured twice with different samples

A method of adding the active carbon to the filter medium of the filter segment 122 is not particularly limited, and the active carbon may be added so as to be substantially uniformly dispersed in the filter medium to which the active carbon is to be added.

### <Microwave Shield>

The microwave shield SD2 provided on the tobacco stick 100 is attached to the cooling segment 121 upstream of the ventilation holes 103, and is located inside the guide portion 13 when the tobacco stick 100 is inserted into the flavor inhaler 10. Thus, the microwave shield SD2 can set the applicator AP to the blocking state in cooperation with the guide portion 13.

However, as long as the microwave shield SD2 is located inside the guide portion 13 when the tobacco stick 100 is inserted into the flavor inhaler 10, for example, the microwave shield SD2 may be attached to the filter segment 122 or may be disposed adjacent to the filter segment 122. In addition, another filter segment adjacent to the cooling segment 121 may be provided, and the microwave shield SD2 may be provided at an end upstream or downstream of another filter segment. The microwave shield SD2 may be formed by disposing a shield member formed in advance at a predetermined position of an aerosol-forming product or by printing the shield member on the filter segment 122.

When the aperture ratio of the microwave shield SD2 is designed in consideration of the shielding of the microwaves and the ventilation resistance, the aperture ratio is, for example, 10% or more, preferably 30% or more, and more preferably 50% or more. The aperture ratio is 90% or less, preferably 80% or less, and more preferably 70% or less. In the case of the above aperture ratio of the microwave shield, the overall ventilation resistance of the flavor inhaler 10 and the tobacco stick 100 is 8 mmH₂O or more, preferably 10 mmH₂O or more, more preferably 12 mmH₂O or more, and 100 mmH₂O or less, preferably 80 mmH₂O or less, and more preferably 60 mmH₂O or less. In this case, it is possible to provide a system that achieves both prevention of microwave leakage and desirable ventilation resistance with a simple device configuration. As described above, the ventilation resistance is measured based on the ISO standard method (ISO6565).

In the tobacco stick 100 configured as described above, a portion of an outer surface of the tipping paper 130 may be coated with a lip release material. The lip release material refers to a material configured to facilitate easy separation of lips of a user and the tipping paper 130 without the lips and the tipping paper 130 substantially being adhered when the user holds the mouthpiece portion 120 of the tobacco stick 100 with the mouth. The lip release material may contain, for example, ethyl cellulose or methyl cellulose. For example, the outer surface of the tipping paper 130 may be coated with the lip release material by applying ethyl cellulose-based ink or methyl cellulose-based ink to the outer surface of the tipping paper 130.

In the present embodiment, the lip release material of the tipping paper 130 is disposed at least in a predetermined mouthpiece region in contact with lips of a user when the user holds the mouthpiece portion 120 in the mouth. More specifically, in the outer surface of the tipping paper 130, a lip release material disposing region R1 (see FIG. 12) covered with the lip release material is defined as a region located between the mouthpiece 101 of the mouthpiece portion 120 and the ventilation holes 103.

Although the ventilation resistance in a longitudinal direction of each tobacco stick 100 configured as described above is not particularly limited, the ventilation resistance is usually 8 mmH₂O or more, preferably 10 mmH₂O or more, more preferably 12 mmH₂O or more, and usually 100 mmH₂O or less, preferably 80 mmH₂O or less, and more preferably 60 mmH₂O or less, from the viewpoint of ease of suction. The ventilation resistance is measured according to an ISO standard method (ISO 6565:2015) using, for example, a filter ventilation resistance measuring device manufactured by Cerulean Corporation. The ventilation resistance refers to the air pressure difference between one end surface (a first end surface) and the other end surface (a second end surface) when air at a predetermined air flow rate (17.5 cc/min) flows from the first end surface to the second end surface in a state where no air permeates through the side surfaces of the tobacco stick 100. The unit is generally represented by mmH₂O. It is known that a relation between the ventilation resistance and the tobacco stick 100 is proportional within a length range (a length of 5 mm to 200 mm) which is usually used, and when the length of the tobacco stick 100 is doubled, the ventilation resistance is also doubled.

The rod-shaped tobacco stick 100 preferably has a columnar shape that satisfies a shape having an aspect ratio of 1 or more defined as follows.

Aspect ratio=h/w

Here, w is a width of the tip 102 of the tobacco stick 100, h is the length in the axial direction, and it is preferable that h≥w. The cross-sectional shape of the tobacco stick 100 is not particularly limited, and may be a polygon, a rounded polygon, a circle, an ellipse, or the like. A width w of the tobacco stick 100 is a diameter when the cross-sectional shape of the tobacco stick 100 is a circle, a major axis when the cross-sectional shape is an ellipse, or a diameter of a circumscribed circle or a major axis of a circumscribed ellipse when the cross-sectional shape is a polygon or a rounded polygon. A length h of the tobacco stick 100 in the axial direction is not particularly limited, and is usually 40 mm or more, preferably 45 mm or more, and more preferably 50 mm or more, for example. The length h is usually 100 mm or less, preferably 90 mm or less, and more preferably 80 mm or less. The width w of the tip 102 of the tobacco stick 100 is not particularly limited, and is usually 5 mm or more, and preferably 5.5 mm or more, for example. The width w is usually 10 mm or less, preferably 9 mm or less, and more preferably 8 mm or less. Although a ratio of the lengths of the cooling segment 121 and the filter segment 122 (cooling segment:filter segment) in the length of the tobacco stick 100 is not particularly limited, from the viewpoint of the delivery amount of the fragrance and the appropriate aerosol temperature, the ratio is usually 0.60 to 1.40:0.60 to 1.40, preferably 0.80 to 1.20:0.80 to 1.20, more preferably 0.85 to 1.15:0.85 to 1.15, still more preferably 0.90 to 1.10:0.90 to 1.10, and particularly preferably 0.95 to 1.05:0.95 to 1.05. By setting the ratio of the lengths of the cooling segment 121 and the filter segment 122 within the above ranges, the cooling effect, the effect of reducing the loss caused by the generated vapor and aerosol adhering to the inner wall of the cooling segment 121 can be achieved, and the adjustment function of the air amount and the flavor of the filter are balanced, and good flavor and flavor intensity can be achieved.

The above embodiments can be freely combined. The above embodiments are examples and are not intended to limit the scope of the invention. The above embodiments can be implemented in various other forms, and various omissions, substitutions, and changes can be made without departing from the gist of the invention. The above embodiments and modifications thereof are included within the scope and gist of the invention as well as within the scope of the invention described in the claims and its equivalents.

In the above embodiments, although the tobacco stick 100 is shown as an example of the “aerosol-forming product” in the present invention, the present invention is not limited thereto. For example, the “aerosol-forming product” may be any filler containing a built-in aerosol source and provided with a microwave shield. The aerosol source includes the above aerosol base material. The aerosol source may contain a flavor source, and the flavor source may be a plant other than tobacco, for example, mint, Chinese herbs, herbs, or the like. Further, the “aerosol-forming product” does not need to have a stick shape, and may have a capsule shape or a cartridge shape.

For example, first and second modifications can be applied to both the first embodiment and second embodiment. Alternatively, the first and second modifications may be combined.

In the present description, at least the following matters are described. In parentheses, corresponding constituent components and the like in the above embodiments are indicated, but the present invention is not limited thereto.
(1) An aerosol generation system (aerosol generation system 1) including:
an aerosol-forming product (tobacco stick 100) including an aerosol source (tobacco rod portion 110);
an accommodating portion (accommodating portion 12) capable of accommodating at least a part of the aerosol-forming product through an opening (opening 12a);
a microwave oscillation unit (high frequency oscillation unit 20) configured to produce a microwave;
a power supply unit (power supply unit 40) configured to supply power to the microwave oscillation unit;
an antenna (21) configured to supply the microwave to the accommodating portion; and
a control unit (control unit 30) configured to control the microwave oscillation unit, in which
the accommodating portion includes a first microwave shield (microwave shield SD1) configured to block the microwave,
the aerosol-forming product includes a second microwave shield (microwave shield SD2) configured to block the microwave and allow air to pass through,
the first microwave shield and the second microwave shield cooperate with each other to form an applicator (applicator AP) configured to confine the microwave,
the applicator transitions between a blocking state in which propagation of the microwave from the applicator to the outside is restricted and a non-blocking state in which propagation of the microwave from the applicator to the outside is enabled, according to a position of the second microwave shield, and
the control unit prohibits supply of the microwave from the microwave oscillation unit according to the position of the second microwave shield.

According to (1), since the supply of the microwave is prohibited according to the position of the second microwave shield of the aerosol-forming product, the supply of the microwave can be prevented when the aerosol-forming product is improperly attached. Therefore, leakage of the microwave to the outside can be reduced.
(2) The aerosol generation system according to (1), further including:
a detection unit (shielding detection sensor 70) configured to detect the position of the second microwave shield, in which
the control unit prohibits the supply of the microwave from the microwave oscillation unit based on a detection result of the detection unit.

According to (2), the position of the second microwave shield is detected by the detection unit. Since the supply of the microwave is prohibited based on the detection result of the detection unit, the supply of the microwave can be prevented when the aerosol-forming product is improperly attached. Therefore, leakage of the microwave to the outside can be reduced.
(3) The aerosol generation system according to (2), in which
the second microwave shield is movable between a first position (first position P1), a second position (second position P2), and a third position (third position P3), the second position being further away from the accommodating portion than the first position, and the third position being further away from the accommodating portion than the second position,
the applicator is in the blocking state when the second microwave shield is in the first position or the second position, and is in the non-blocking state when the second microwave shield is in the third position, and
the control unit allows the supply of the microwave from the microwave oscillation unit when the second microwave shield is in the first position, and prohibits the supply of the microwave from the microwave oscillation unit when the second microwave shield is in the second position and the third position.

According to (3), since the supply of the microwave is prohibited when the second microwave shield is in the second position, the leakage of the microwave to the outside can be prevented as compared with a case where the supply of the microwave is stopped after the applicator enters in the non-blocking state.
(4) The aerosol generation system according to (3), in which
the detection unit transmits a signal to the control unit when detecting that the second microwave shield is in the first position, and
the control unit allows the supply of the microwave from the microwave oscillation unit when receiving the signal.

According to (4), since the supply of the microwave is allowed when the signal indicating that the second microwave shield is in the first position is received, the supply of the microwave can be performed when the applicator is in the blocking state.
(5) The aerosol generation system according to (4), in which
the control unit stops the supply of the microwave from the microwave oscillation unit when the reception of the signal is cut off.

According to (5), since the supply of the microwave is stopped when the reception of the signal indicating that the second microwave shield is in the first position is cut off, the supply of the microwave can be stopped in the blocking state. Therefore, the leakage of the microwave to the outside can be prevented as compared with a case where the supply of the microwave is stopped after the non-blocking state.
(6) The aerosol generation system according to (1), further including:
a first detection unit (shielding detection sensor 70) configured to detect the position of the second microwave shield; and
a second detection unit (insertion detection sensor 71) configured to detect insertion of the aerosol-forming product into the accommodating portion, in which
the control unit prohibits the supply of the microwave from the microwave oscillation unit based on detection results of the first detection unit and the second detection unit.

According to (6), since the supply of the microwave is prohibited based on the detection results related to the position of the second microwave shield and the insertion of the aerosol-forming product into the accommodating portion, the leakage of the microwave to the outside can be prevented more reliably.
(7) The aerosol generation system according to (6), in which
when the first detection unit detects that the position of the second microwave shield is a first position (first position P1) and the second detection unit detects the insertion of the aerosol-forming product into the accommodating portion, the control unit allows the supply of the microwave from the microwave oscillation unit, and
when the first detection unit does not detect that the position of the second microwave shield is in the first position or when the second detection unit does not detect the insertion of the aerosol-forming product into the accommodating portion, the control unit prohibits the supply of the microwave from the microwave oscillation unit.

According to (7), when the first detection unit does not detect that the position of the second microwave shield is the first position, or when the second detection unit does not detect the insertion of the aerosol-forming product into the accommodating portion, the supply of the microwave is prohibited, and therefore, the supply of the microwave is not performed unless the applicator AP is definitely in the blocking state. Therefore, leakage of the microwave to the outside can be prevented more reliably.
(8) The aerosol generation system according to (7), in which
when the aerosol-forming product is detached from the accommodating portion, a signal from the second detection unit is cut off, and then a signal from the first detection unit is cut off, and
when the signal from the first detection unit is cut off or after the signal from the first detection unit is cut off, the applicator transitions from the blocking state to the non-blocking state.

According to (8), since the applicator is in the blocking state until the signals from the first detection unit and the second detection unit are cut off or until after the signals from the first detection unit and the second detection unit are cut off, the microwave can be prevented from being supplied in the non-blocking state.
(9) The aerosol generation system according to (7), in which
when the aerosol-forming product is detached from the accommodating portion, a signal from the first detection unit is cut off, and then a signal from the second detection unit is cut off, and
when the signal from the second detection unit is cut off or after the signal from the second detection unit is cut off, the applicator transitions from the blocking state to the non-blocking state.

According to (9), since the applicator is in the blocking state until the signals from the first detection unit and the second detection unit are cut off or until after the signals from the first detection unit and the second detection unit are cut off, the applicator is in the blocking state, the microwave can be prevented from being supplied in the non-blocking state.
(10) The aerosol generation system according to any one of (1) to (9), in which
the second microwave shield is provided closer to the opening than the aerosol source when the aerosol-forming product is accommodated, and
a conductive portion (conductive portion 104) is provided on an outer peripheral surface of the aerosol-forming product, the conductive portion being electrically connected to the second microwave shield and extending from the position of the second microwave shield toward the aerosol source.

According to (10), since the conductive portion extending from the position of the second microwave shield toward the aerosol source is provided, the area where the position of the second microwave shield can be detected is increased. In addition, when the aerosol-forming product is attached or detached, the period during which the applicator is in the blocking state can be increased.
(11) The aerosol generation system according to (10), further including:
a guide portion (guide portion 13) provided with the opening and configured to guide the aerosol-forming product to the accommodating portion, in which
a plurality of protrusions (protrusions 13a) are provided on an inner peripheral surface of the guide portion from the opening toward the accommodating portion.

According to (11), since the plurality of protrusions are provided on the inner peripheral surface of the guide portion from the opening toward the accommodating portion, insertion resistance when the aerosol-forming product is inserted into the guide portion can be reduced.
(12)
An aerosol-forming product (tobacco stick 100) heated by a microwave, the aerosol-forming product including:
an aerosol source (tobacco rod portion 110);
a microwave shield (microwave shield SD2) disposed side by side with the aerosol source in a predetermined direction and configured to block the microwave and allow air to pass through; and
a conductive portion (conductive portion 104) electrically connected to the microwave shield, in which
the conductive portion is provided on an outer peripheral surface of the aerosol-forming product and extends from a position of the microwave shield toward the aerosol source in the predetermined direction.

According to (12), since the conductive portion extending from the position of the microwave shield toward the aerosol source is provided, when the aerosol-forming product is heated by the microwave, a space for blocking the microwave can be formed by the microwave shield and the conductive portion.

What is claimed is:

1. An aerosol generation system comprising:
an aerosol-forming product including an aerosol source;
an accommodating portion capable of accommodating at least a part of the aerosol-forming product through an opening;
a microwave oscillation unit configured to produce a microwave;
a power supply unit configured to supply power to the microwave oscillation unit;
an antenna configured to supply the microwave to the accommodating portion; and
a control unit configured to control the microwave oscillation unit, wherein
the accommodating portion includes a first microwave shield configured to block the microwave,
the aerosol-forming product includes a second microwave shield configured to block the microwave and allow air to pass through,
the first microwave shield and the second microwave shield cooperate with each other to form an applicator configured to confine the microwave,
the applicator transitions between a blocking state in which propagation of the microwave from the applicator to the outside is restricted and a non-blocking state in which propagation of the microwave from the applicator to the outside is enabled, according to a position of the second microwave shield, and
the control unit prohibits supply of the microwave from the microwave oscillation unit according to the position of the second microwave shield.

2. The aerosol generation system according to claim 1, further comprising:
a detection unit configured to detect the position of the second microwave shield, wherein
the control unit prohibits the supply of the microwave from the microwave oscillation unit based on a detection result of the detection unit.

3. The aerosol generation system according to claim 2, wherein
the second microwave shield is movable between a first position, a second position, and a third position, the second position being further away from the accommodating portion than the first position, and the third position being further away from the accommodating portion than the second position,
the applicator is in the blocking state when the second microwave shield is in the first position or the second position, and is in the non-blocking state when the second microwave shield is in the third position, and
the control unit allows the supply of the microwave from the microwave oscillation unit when the second microwave shield is in the first position, and prohibits the supply of the microwave from the microwave oscillation unit when the second microwave shield is in the second position and the third position.

4. The aerosol generation system according to claim 3, wherein
the detection unit transmits a signal to the control unit when detecting that the second microwave shield is in the first position, and
the control unit allows the supply of the microwave from the microwave oscillation unit when receiving the signal.

5. The aerosol generation system according to claim 4, wherein
the control unit stops the supply of the microwave from the microwave oscillation unit when the reception of the signal is cut off.

6. The aerosol generation system according to claim 1, further comprising:
a first detection unit configured to detect the position of the second microwave shield; and
a second detection unit configured to detect insertion of the aerosol-forming product into the accommodating portion, wherein
the control unit prohibits the supply of the microwave from the microwave oscillation unit based on detection results of the first detection unit and the second detection unit.

7. The aerosol generation system according to claim 6, wherein
when the first detection unit detects that the position of the second microwave shield is a first position and the second detection unit detects the insertion of the aerosol-forming product into the accommodating portion, the control unit allows the supply of the microwave from the microwave oscillation unit, and
when the first detection unit does not detect that the position of the second microwave shield is in the first position or when the second detection unit does not detect the insertion of the aerosol-forming product into the accommodating portion, the control unit prohibits the supply of the microwave from the microwave oscillation unit.

8. The aerosol generation system according to claim 7, wherein
when the aerosol-forming product is detached from the accommodating portion, a signal from the second detection unit is cut off, and then a signal from the first detection unit is cut off, and
when the signal from the first detection unit is cut off or after the signal from the first detection unit is cut off, the applicator transitions from the blocking state to the non-blocking state.

9. The aerosol generation system according to claim 7, wherein
when the aerosol-forming product is detached from the accommodating portion, a signal from the first detection unit is cut off, and then a signal from the second detection unit is cut off, and
when the signal from the second detection unit is cut off or after the signal from the second detection unit is cut off, the applicator transitions from the blocking state to the non-blocking state.

10. The aerosol generation system according to claim 1, wherein
the second microwave shield is provided closer to the opening than the aerosol source when the aerosol-forming product is accommodated, and
a conductive portion is provided on an outer peripheral surface of the aerosol-forming product, the conductive portion being electrically connected to the second microwave shield and extending from the position of the second microwave shield toward the aerosol source.

11. The aerosol generation system according to claim 10, further comprising:
a guide portion provided with the opening and configured to guide the aerosol-forming product to the accommodating portion, wherein
a plurality of protrusions are provided on an inner peripheral surface of the guide portion from the opening toward the accommodating portion.

12. An aerosol-forming product heated by a microwave, the aerosol-forming product comprising:
an aerosol source;
a microwave shield disposed side by side with the aerosol source in a predetermined direction and configured to block the microwave and allow air to pass through; and
a conductive portion electrically connected to the microwave shield, wherein
the conductive portion is provided on an outer peripheral surface of the aerosol-forming product and extends from a position of the microwave shield toward the aerosol source in the predetermined direction.
